(19) United States
(12) Patent Application Publication
(10) Pub. No.: US 2026/0039157 A1
(43) Pub. Date: Feb. 5, 2026

(54) AXIAL FLUX ELECTRIC MACHINE POLE PIECE WITH CONDUCTIVE RIBBONS

(71) Applicant: Conifer Systems, Inc., Middletown, DE (US)

(72) Inventors: Yateendra B Deshpande, Sunnyvale, CA (US); Ankit Somani, Los Altos, CA (US); Nicholas Peter Deick, Newark, CA (US); Farid Naghavi, Bryan, TX (US); Bryce Wallis, San Jose, CA (US)

(21) Appl. No.: 19/356,532

(22) Filed: Oct. 13, 2025

Related U.S. Application Data
(63) Continuation-in-part of application No. 18/241,159, filed on Aug. 31, 2023, now Pat. No. 12,456,894.
(60) Provisional application No. 63/403,281, filed on Sep. 1, 2022.

(51) Int. Cl. H02K 1/14

(52) U.S. Cl. CPC H02K 1/14

(57) ABSTRACT

Axial flux electric machines and associated methods are disclosed herein. One disclosed axial flux electric machine includes a stator having a plurality of pole pieces, a set of coiled ribbons of conductive material forming at least part of a pole piece in the plurality of pole pieces, and an insulative material that isolates each coiled ribbon of conductive material in the set of coiled ribbons of conductive material. Each coiled ribbon of conductive material is adjacent to other coiled ribbons of conductive material in the set of coiled ribbons of conductive material in an axial direction of the axial flux electric machine. An axial direction of the set of coiled ribbons of conductive material is substantially parallel to the axial direction of the axial flux electric machine.

### CROSS REFERENCE TO RELATED APPLICATIONS

This application is a continuation-in-part of U.S. patent application Ser. No. 18/241,159, filed Aug. 31, 2023, which claims the benefit of U.S. Provisional Patent Application No. 63/403,281 filed Sep. 1, 2022, both of which are incorporated by reference herein in their entireties for all purposes.

### BACKGROUND

Axial flux electric machines were first patented in U.S. Pat. No. 405,858 by Nikola Tesla in 1889. However, the usage of such machines in the commercial space had been largely rare until the invention of the high-performance Neodymium-Iron-Boron (Nd—Fe—B) permanent magnet material in 1983. Since then, axial flux electric machines have gained widespread adoption on a rapid scale due to their high efficiency and compact nature as compared to other technologies. The emergence of environmentally friendly technologies like electric vehicles have further boosted the application space of axial flux electric machines. Today, axial flux electric machines are used in electric cars, robots of various sizes and types, and electric or hybrid propulsion systems for aircraft. It is generally desirable to reduce the power losses produced in electric machines to thereby improve the machines' energy conversion efficiency. It is also desirable to keep electric machines lightweight and compact and to reduce their upfront manufacturing costs.

Axial flux electric machines typically comprise a stationary assembly and a rotating assembly. An axial flux electric machine comprises, in its most basic form, at least three parts: a stator, a rotor, and a rotor shaft. Stators are stationary parts, whereas rotors and rotor shafts are rotating parts. An axial flux electric machine can also include more than one stator or more than one rotor. Two examples of axial flux electric machine are shown in FIG. 1 in which the axial cross section 100 shows an axial flux electric machine having one rotor and two stators, and axial cross section 110 shows an axial flux electric machine having one stator and two rotors. Radial cross section 111 shows a stator in either axial flux electric machine. Radial cross section 112 shows a rotor in either axial flux electric machine. As used herein the term radial cross section refers to the view provided by looking at the axial flux electric machine in the direction of the axis of the axial flux electric machine and the term axial cross section refers to the view provided by looking at the axial flux electric machine in-line with a radius of a rotor of the axial flux electric machine. The axial flux electric machine functions by exchanging electric energy and the rotational momentum of the rotating parts using a magnetic field that is in the direction of motion of the rotating parts.

The manner in which electrical energy and rotational momentum are exchanged in an axial flux electric machine depends on the specific design of the machine. With respect to axial electric motors, the design can include permanent magnets and controllably magnetized magnets. The permanent magnets can be on either the rotor or the stator and the controllably magnetized magnets can be on either the rotor or the stator. Stator 101 and rotor 102 can be the stators and rotors on the two different kinds of illustrated axial flux electric machines as illustrated in FIG. 1. In the provided examples, the permanent magnets are on the rotor while the stator can be controllably magnetized to rotate the rotor. However, in alternative examples, the permanent magnets are on the stator and the rotor can be controllably magnetized.

The controllably magnetized magnets can include conductive coil windings and soft magnetic material. In the axial flux electric machines of FIG. 1, the stator comprises coil windings 105 wherein the coils are made of conductive material, and terminals of the electrically conductive coils are exposed externally to be energized by an external electrical circuit. Typical conductive materials for coils are aluminum and copper. As shown in FIG. 1, a conductive wire is coiled around a trapezoidal shaped pole piece 106 to form coil windings 105. Such pole pieces are manufactured using complicated molding processes using soft magnetic materials and laminations. The soft magnetic material is what allows the device to be configurably magnetized under the influence of current applied to the coiled wire. As shown in axial cross section 100, portions of the axial flux electric machine (e.g., rotor 102, permanent magnets 103, coil windings 105, pole piece 106) may be contained within motor housing 107.

The rotor can be connected to a rotor shaft to transfer the rotational momentum of the rotor to an external system. As illustrated in FIG. 1, a rotor 102 can house a circular array of specifically spaced, alternating pole, permanent magnets 103 and be coupled to rotor shaft 109. The rotor is typically supported by one or more bearings 108 that allow rotation of the rotor about an axis of rotation while maintaining a substantially uniform air-gap between the rotor and stator. In the example of an axial flux motor in accordance with the examples in FIG. 1, when the coils of the stator are energized, the current flowing through the coils generates magnetic fields between two adjacent coils having opposite polarities, which alternate, and the magnetic flux generated by the coils repels or attracts a permanent magnet close to them, inducing torque and rotation of the rotor. The rotor shaft coupled to the rotor, in turn, transfers the torque to an externally connected load.

### SUMMARY

Electric machines that convert electrical power to rotational mechanical power or vice versa and associated methods and systems are disclosed herein. The electrical machines may be permanent magnet synchronous alternating current (AC) electric machines in the form of axial flux electric machines. The axial flux electric machines may be either motors or generators.

There are several drawbacks to prior art axial flux electric machines. For example, the machines do not utilize the flux carrying capacity of electrical steel and underutilize the magnetic flux of the permanent magnets. Furthermore, manufacturing of trapezoidal shaped pole pieces, which typically uses laminated electrical steel, is challenging as standard electrical steel punching and joining methods are not readily employable. Another possibility to resolve this challenge is to employ a soft magnetic composite, formed using such soft magnetic materials as iron or silicon steel, which allows sintering individual pole pieces into a desired shape and concentrates the rotor's permanent magnet flux. However, soft magnetic composites typically achieve lower saturation levels of magnetic flux.

In specific embodiments of the invention disclosed herein, a pole piece with conductive ribbons is provided that, in specific embodiments, overcomes the drawbacks of the prior art approaches described above and allows for an alternative low-cost manufacturing process while significantly reducing electrical machine losses.

In specific embodiments of the invention, an axial flux electric machine is provided. The axial flux electric machine comprises a stator having a plurality of pole pieces, a rotor spaced apart from the stator in an axial direction of the axial flux electric machine, and a coiled ribbon of conductive material forming at least part of a pole piece in the plurality of pole pieces. An axial direction of the coiled ribbon of conductive material is substantially parallel to the axial direction of the axial flux electric machine. In some embodiments, the axial flux electric machine further comprises a coiled ribbon of soft magnetic material forming at least part of the pole piece. In these embodiments, the coiled ribbon of soft magnetic material and the coiled ribbon of conductive material can be commonly coiled in an interleaved composite material coil. In some embodiments, the axial flux electric machine further comprises a coiled ribbon of insulative material forming at least part of the pole piece wherein the coiled ribbon of soft magnetic material, the coiled ribbon of conductive material, and the coiled ribbon of insulative material are commonly coiled in the interleaved composite material coil. In some embodiments, the conductive material is at least partially sheathed in insulating material such that the ribbon of conductive material comprises a conductive core that is insulated from ohmic contact when the conductive material is coiled either upon itself or into an interleaved composite material coil. The sheathing can be around the entire circumference of a segment of the ribbon or it can be partial and only cover a top or bottom side of a segment of the ribbon.

In specific embodiments of the invention, an axial flux electric machine is provided. The axial flux electric machine comprises a stator having a plurality of pole pieces, a rotor spaced apart from the stator in an axial direction of the axial flux electric machine, and a coil of conductive material forming at least part of a pole piece in the plurality of pole pieces. The coil of conductive material forms the pole piece as a free-standing structure.

In specific embodiments of the invention, an axial flux electric machine is provided. The axial flux electric machine comprises a stator having a plurality of pole pieces, a rotor spaced apart from the stator in an axial direction of the axial flux electric machine, and a coiled ribbon of conductive material forming at least part of a pole piece in the plurality of pole pieces. The radial surface area of the coiled ribbon forms at least half of a radial surface area of the pole piece. As used herein, the term “radial surface area” refers to a surface area measured perpendicular to the axial direction of the axial flux electric machine.

In specific embodiments of the invention, an axial flux electric machine is provided. The axial flux electric machine comprises: a stator having a plurality of pole pieces, a set of coiled ribbons of conductive material forming at least part of a pole piece in the plurality of pole pieces, and an insulative material that isolates each coiled ribbon of conductive material in the set of coiled ribbons of conductive material. Each coiled ribbon of conductive material is adjacent to other coiled ribbons of conductive material in the set of coiled ribbons of conductive material in an axial direction of the axial flux electric machine. An axial direction of the set of coiled ribbons of conductive material is substantially parallel to the axial direction of the axial flux electric machine.

In specific embodiments of the invention, an axial flux electric machine is provided. The axial flux electric machine comprises: a stator having a plurality of pole pieces, a first coiled ribbon of conductive material forming at least part of a pole piece in the plurality of pole pieces, and a second coiled ribbon of conductive material forming at least part of the pole piece. The first coiled ribbon of conductive material is coiled in a first direction. The second coiled ribbon of conductive material is coiled in the first direction. The second coiled ribbon of conductive material and the first coiled ribbon of conductive material are adjacent in an axial direction of the axial flux electric machine. A winding of the first coiled ribbon of conductive material exits an axial plane of the first coiled ribbon of conductive material and enters an axial plane of the second coiled ribbon of conductive material. The winding electrically connects the second coiled ribbon of conductive material and the first coiled ribbon of conductive material.

In specific embodiments of the invention, an axial flux electric machine is provided. The axial flux electric machine comprises: a stator having a plurality of pole pieces, a coiled ribbon of conductive material forming at least part of a pole piece in the plurality of pole pieces and having a first width in an axial direction of the axial flux electric machine, a coiled ribbon of soft magnetic material forming at least part of the pole piece and having a second width in the axial direction of the axial flux electric machine, and an insulative material. The coiled ribbon of soft magnetic material and the coiled ribbon of conductive material are commonly coiled in an interleaved composite material coil. An axial direction of the interleaved composite material coil is substantially parallel to the axial direction of the axial flux electric machine. The insulative material isolates the coiled ribbon of conductive material from the coiled ribbon of soft magnetic material. The second width is larger than the first width.

### BRIEF DESCRIPTION OF THE DRAWINGS

The accompanying drawings illustrate various embodiments of the systems, the methods, and various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates axial flux electric machines in accordance with the related art.

FIG. 2 illustrates an exploded view of an example of an axial flux electric machine in accordance with specific embodiments of the invention.

FIG. 3 illustrates an example of a rotor in accordance with specific embodiments of the invention.

FIG. 4 illustrates an example of a stator in accordance with specific embodiments of the invention.

FIG. 5 illustrates an example of an interleaved composite material coil in accordance with specific embodiments of the invention.

FIG. 6 illustrates an example of a piece of composite material ribbon in accordance with specific embodiments of the invention.

FIG. 7 illustrates a magnified view of an example of a turn corner of an interleaved composite material coil in accordance with specific embodiments of the invention.

FIG. 8 illustrates a compound coil in accordance with specific embodiments of the invention.

FIG. 9 illustrates an example of an assembled pole piece with a first interleaved composite material coil and a second interleaved composite material coil in accordance with specific embodiments of the invention.

FIG. 10 illustrates an exploded view of the assembled pole piece in FIG. 9.

FIG. 11 illustrates a process for forming a fold in an interleaved composite material coil in accordance with specific embodiments of the invention.

FIG. 12 illustrates a pole piece having a fold as an internal electrical connection in accordance with specific embodiments of the invention.

FIG. 13 illustrates a fold for a compound coil in accordance with specific embodiments of the invention.

FIGS. 14 illustrates a set of pairs of coils having additive magnetic flux and external electrical connections in accordance with specific embodiments of the invention.

FIG. 15 illustrates an example of a stator housing in accordance with specific embodiments of the invention.

FIG. 16 illustrates another example of a stator housing in accordance with specific embodiments of the invention.

FIG. 17 illustrates a cross-sectional view of an example of an assembled axial flux electric machine in accordance with specific embodiments of the invention.

FIG. 18 illustrates a cross-sectional view of an example of an assembled axial flux electric machine with a mechanical differential assembly in accordance with specific embodiments of the invention.

FIG. 19 illustrates an example of gears of the mechanical differential assembly in accordance with specific embodiments of the invention.

FIG. 20 illustrates an example of a mechanical differential assembly in accordance with specific embodiments of the invention.

FIG. 21 illustrates an example of axially stacked axial flux electric machines in accordance with specific embodiments of the invention.

FIG. 22 illustrates an example of a pole piece with a soft magnetic core in accordance with specific embodiments of the invention.

FIG. 23 illustrates examples of pieces of composite material ribbons with insulative material in accordance with specific embodiments of the invention.

FIG. 24 illustrates cross sections of examples of coils with insulative material in accordance with specific embodiments of the invention.

FIG. 25 illustrates examples of pieces of composite material ribbons with multiple ribbons of conductive material in accordance with specific embodiments of the invention.

FIG. 26 illustrates an example of a compound interleaved composite material coil which includes four coils of conductive material in accordance with specific embodiments of the invention.

FIG. 27 illustrates the process for forming an internal connection in the form of a gradual fold in a single continuous strip of conductive material in accordance with specific embodiments of the invention.

FIG. 28 illustrates an example of a gradual fold winding that acts as an internal connection between two coiled ribbons that are made of a single continuous strip of conductive material in accordance with specific embodiments of the invention.

FIG. 29 illustrates an example of a pole piece that has been formed using a gradual fold in accordance with specific embodiments of the invention.

FIG. 30 illustrates a gradual fold pattern to allow a first set of ribbons of conductive material in a first coil to connect to a second set of ribbons of conductive material in a second coil in accordance with specific embodiments of the invention.

FIG. 31 illustrates the results of a simulation of torque for an electric motor with a soft magnetic core as described herein and an electric motor without a soft magnetic core.

FIG. 32 illustrates an example of two coils with split ribbons that are connected in series in accordance with specific embodiments of the invention.

FIG. 33 illustrates two coils with split ribbons with each ribbon of a coil connected in parallel in accordance with specific embodiments of the invention.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Methods and systems related to electric machines in accordance with the summary above are disclosed in detail herein. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

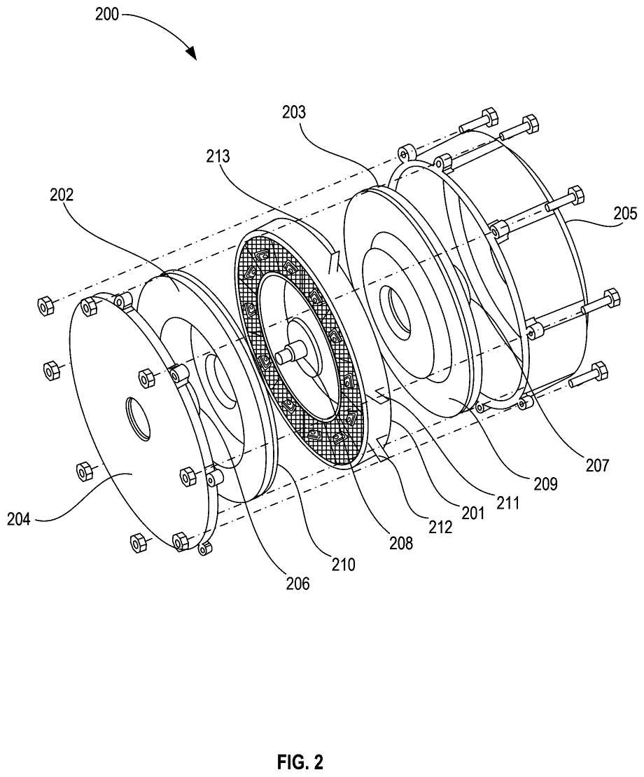

FIG. 2 illustrates an exploded view of an axial flux electric machine 200 (hereinafter, an axial flux electric machine is often referred to as a machine or an electric machine) in accordance with specific embodiments of the invention. The machine has one stator 201 and two rotors 202, 203, such that one rotor is on one side of the stator and the other rotor is on the opposite side of the stator. The stator and the rotors are axially positioned along an axis of rotation of the rotors. The rotors are adjacent to the stator but there is a gap between them. When assembled, the rotors are spaced apart from the stator in an axial direction of the axial flux electric machine 200 to form this gap. For example, the space between the stator and a rotor can be on the order of 0.1 millimeter to 3 millimeters. The machine includes an external support structure in the form of an external housing which comprises external housing parts 204, 205, a rotor shaft 208, and rotor support bearings 206, 207. When assembled, the rotor shaft is fixedly connected to each of the two rotors 202, 203. The bearings 206, 207 are in turn supported by the stator housing. The bearings 206, 207 allow rotation of the rotor shaft relative to the stator, which, as mentioned, is stationary. The stator comprises stator electrical contact terminals 211, 212, 213 for supplying current to the stator from an external power source. Each rotor 202, 203 comprises a permanent magnetic disc 209, 210 on the rotor's side that faces the stator 201.

In specific embodiments of the invention, the axial flux electric machine may include only one rotor and one stator. In other embodiments of the invention, the axial flux electric machine may include only one rotor and two stators, such that one stator is on one side of the rotor and the other stator is on the opposite side of the rotor. In alternative embodiments, the axial flux electric machine can include a larger number of rotors and stators which impart torque on a shared rotor shaft. In specific embodiments of the invention, two rotors that are driven by a single stator can distribute torque to two separate rotor shafts. In specific embodiments, two rotors that are driven by a single stator can be connected to a mechanical differential assembly such that they impart torque on a shared rotor shaft with two portions that can also be rotated independently of each other. In some embodiments, the rotor shaft is hollow.

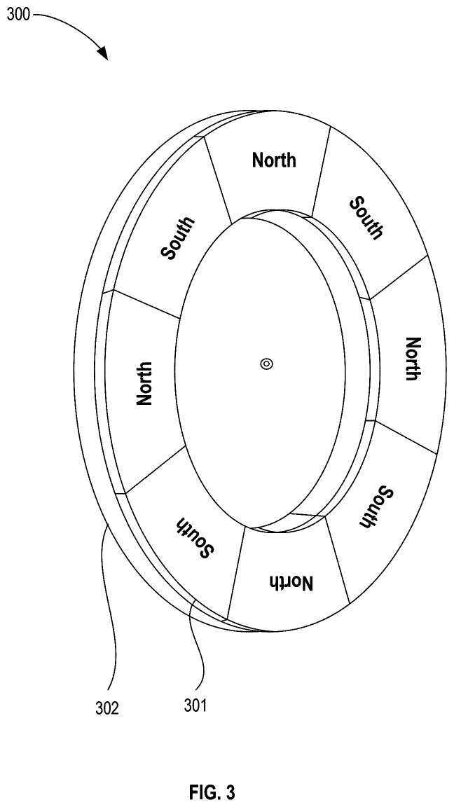

FIG. 3 illustrates a rotor 300 in accordance with one embodiment of the invention. Permanent magnetic disc 301 is attached to rotor support structure 302, which provides mechanical support to the disc. Permanent magnetic disc 301 is magnetized in a way to create a substantially axial magnetic field with alternating north and south magnetic poles as shown in FIG. 3. In another embodiment, permanent magnetic disc 301 is achieved by joining a plurality of permanent magnets together or joining a plurality of permanent magnets to rotor support structure 302. In either embodiment, it is not necessary that the permanent magnets fill the entirety of the volume of permanent magnetic disc 301 as depicted in FIG. 3. Each rotor's rotor support structure is, in turn, attached to rotor shaft 208 in FIG. 2 in a way that allows for transmission of torque without relative movement at the contact surface between the rotor shaft and the rotor support structure and that all parts of the rotor spin at the same rotational velocity about the axis defined by the support bearings 206, 207, in FIG. 2.

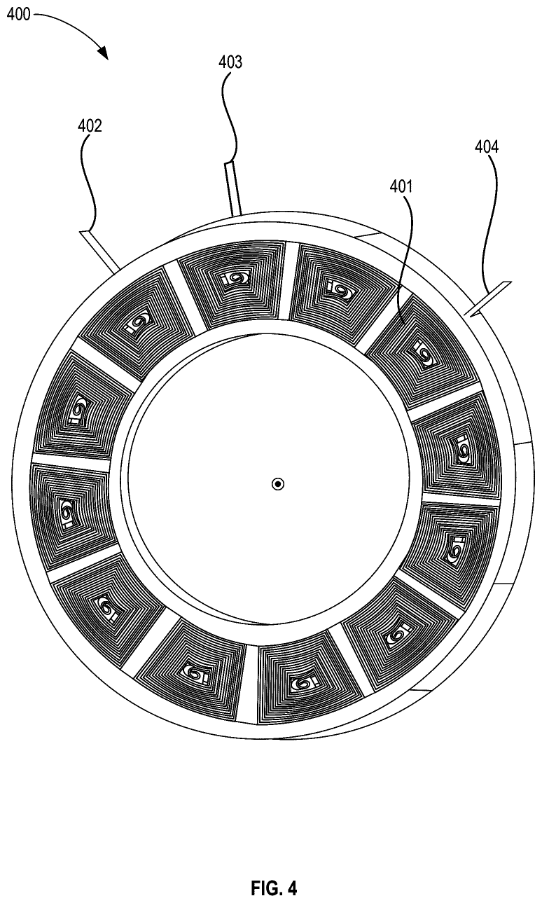

FIG. 4 illustrates a stator 400 in accordance with specific embodiments of the invention. Stator 400 includes a plurality of stator electrical contact terminals 402, 403, 404. The stator further comprises a plurality of pole pieces such as pole piece 401. In this example, each pole piece includes two interleaved composite material coils (in FIG. 4, only one interleaved composite material coil is shown). For each pole piece, the second interleaved composite material coil is adjacent to the illustrated interleaved composite material coil in the axial direction and is therefore hidden from view in FIG. 4.

In specific embodiments, each pole piece may include only one interleaved composite material coil or multiple interleaved composite material coils. As will be described below, in some embodiments each pole piece may include multiple interleaved composite material coils including adjacent coils that are coiled in the same direction and that coil from the outside of the coil to the inside of the coil, and adjacent coils that are coiled in the same direction and that coil from the inside of the coil to the outside of the coil. As used herein, the term “direction” when used with reference to the direction of coiling can be either counter-clockwise or clockwise from a fixed plane of reference. As used herein, the term “inward” can refer to a coil which coils from the outside of the coil to the inside, and “outward” can refer to a coil which coils from the inside of the coil to the outside. Accordingly, the conductive ribbons and coiled interleaved composite material coils disclosed herein will each produce a magnetic flux that is in the axial direction of the axial flux electric machine and that is additive with other coils that are coiled in the same direction. Notably, an inwardly and counter-clockwise coiled ribbon will create the same magnetic flux as an outwardly and counter-clockwise coiled ribbon. As such, the interleaved composite material coil illustrated as part of pole piece 401 in FIG. 4, and the second interleaved composite material coil that forms part of pole piece 401 will both produce an additive magnetic flux in an axial direction relative to stator 400 because they are both coiled in the same direction.

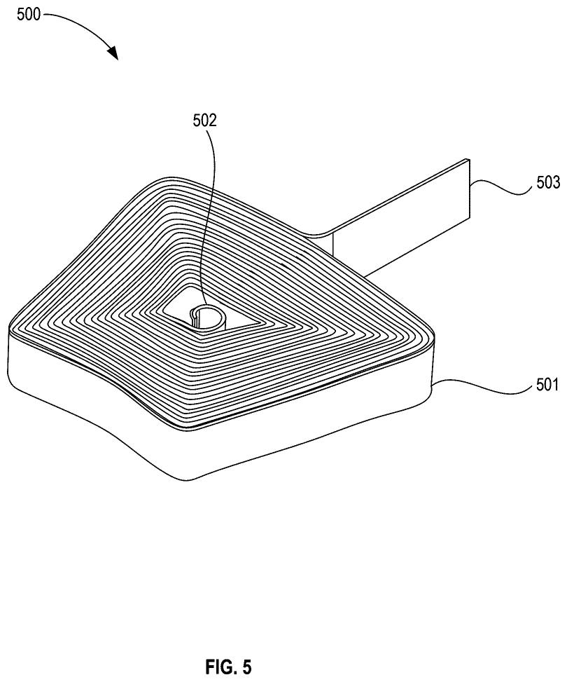

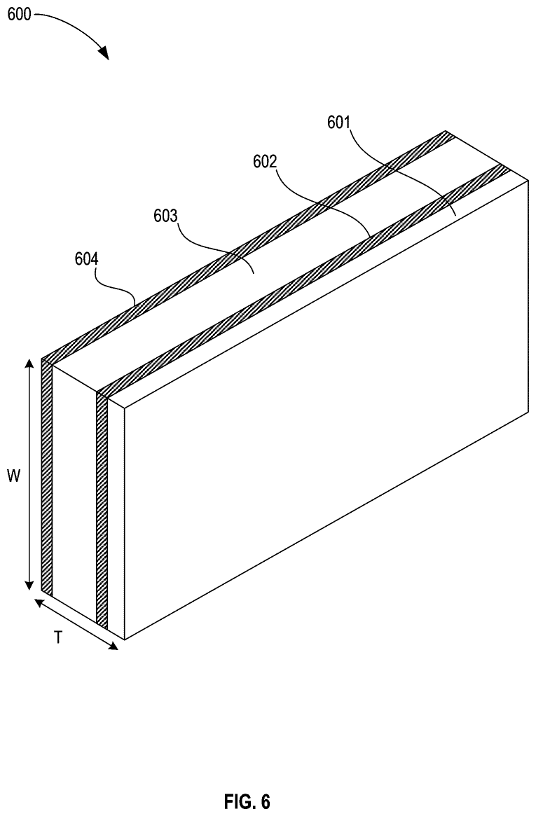

FIG. 5 illustrates an interleaved composite material coil 500 in accordance with specific embodiments of the invention. The interleaved composite material coil 500 is formed by coiling a composite material ribbon 501 inwardly and counterclockwise (i.e., counterclockwise from the outside of the coil to the inside of the coil). When installed, the interleaved composite material coil's axial direction will be substantially parallel to the axial direction of the axial flux electric machine. FIG. 6 illustrates a piece of composite material ribbon 600 in accordance with one embodiment of the invention. The composite material ribbon 600, in turn, is formed by interleaving, from the right to the left of FIG. 6, a ribbon of soft magnetic material 601, a ribbon of insulative material 602, a ribbon of conductive material 603, and a second ribbon of insulative material 604—such that on each side of the ribbon of conductive material there is one ribbon of insulative material. The material for the ribbon of soft magnetic material can be one of iron, silicon steel, magnetic cobalt alloy, amorphous steel, and any other suitable material. The material for the ribbon of conductive material can be one of copper, aluminum, and any other suitable material. Instead of separate ribbons of material, the insulative material could be a part of the ribbon of conductive material, part of the ribbon of soft magnetic material, or both. The insulative material could be part of the ribbon in that it sheathes at least a portion of the conductive material or the soft magnetic material. The sheathing could be partial because the ends of the ribbon of conductive material will need to have ohmic connections to a bias voltage source. However, within the coil, all sides of the ribbon could be sheathed in insulative material. The cross section could appear the same as in FIG. 6, with an optional additional layer of insulative material along the illustrated exposed side of the ribbon of soft magnetic material 601.

As shown in FIG. 6, each ribbon of a particular material has two cross-sectional straight sides: W, the width of the ribbon as measured in an axial direction of the interleaved composite material coil 500, and T, the thickness of the ribbon as measured in a radial direction of the interleaved composite material coil 500. The composite material ribbon can include multiple ribbons of the same material. For example, two ribbons of conductive material can be pressed together in the composite material ribbon. This has the beneficial effect of doubling the thickness of the conductive material and thereby decreasing by half (assuming all other factors are constant) the ohmic resistance of the conductive material. This is particularly beneficial, because when, during operation, the interleaved composite material coil is energized, the pole of its magnetic flux alternates and the lower the resistance through the conductive material, the faster the pole changes. In this way, the thickness of the coiled ribbon of the conductive material and therefore, the performance of the axial flux electric machine are easily adjustable: the larger the ribbon thickness, the lower the resistance, and the faster the pole switching rate. Conversely, the smaller the ribbon thickness, the higher the resistance, and the slower the pole switching rate. However, increasing the thickness of the coiled ribbon of the conductive material in this manner adds more weight to the machine and increases manufacturing cost. These principles also hold true for the width of the ribbon W. An appropriate design thickness of the ribbon can be determined as a trade-off among weight, manufacturing cost, and performance.

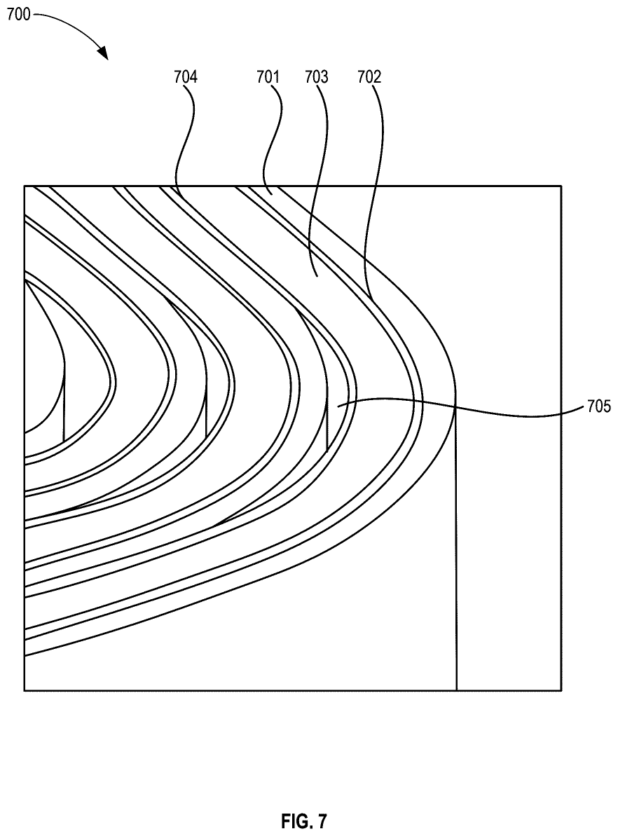

FIG. 7 is a zoomed in view 700 of a turn corner of an interleaved composite material coil in accordance with specific embodiments of the invention. Because the interleaved composite material coil is formed by coiling the composite material ribbon, the interleaved composite material coil comprises a coiled ribbon of soft magnetic material 701, a coiled ribbon of insulative material 702, a coiled ribbon of conductive material 703, and a second coiled ribbon of insulative material 704—each of which is commonly coiled in the interleaved composite material coil. The adjacent turns of the interleaved composite material coil are separated by an air gap 705. The ribbons thusly coiled can form part of pole piece 401 in FIG. 4.

In specific embodiments, the interleaved composite material coil 500 may not include any coiled ribbon of insulative material. For example, the ribbon of conductive material, and therefore, the coiled ribbon of conductive material, can be coated with an electrically insulating film or otherwise be sheathed in insulative material. Alternatively, the various ribbons in the interleaved composite material coil 500 can each be separated by an air gap instead of insulating material. In some embodiments, the composite material ribbon 600 may not include any ribbon of soft magnetic material and consequently, the interleaved composite material coil may not include any coiled ribbon of soft magnetic material. In specific embodiments, the coiled ribbon of conductive material and at least one other coiled ribbon of conductive material are pressed together and commonly coiled in a composite conductive coil; in such embodiments, the interleaved composite material coil comprises the composite conductive coil.

As, in specific embodiments, the interleaved composite material coil's axial direction is substantially parallel to the axial direction of the axial flux electric machine, each of the interleaved composite material coil's constituent coiled ribbons has an axial direction that is substantially parallel to the axial direction of the axial flux electric machine. Thus, for example, in the embodiment illustrated in FIG. 7, the axial direction of the coiled ribbon of conductive material 703 is substantially parallel to the axial direction of the axial flux electric machine. The coiled ribbon of conductive material forms a set of windings, and an air gap 705 separates adjacent windings in the set of windings. As seen, the coiled ribbon of conductive material forms at least two full concentric turns.

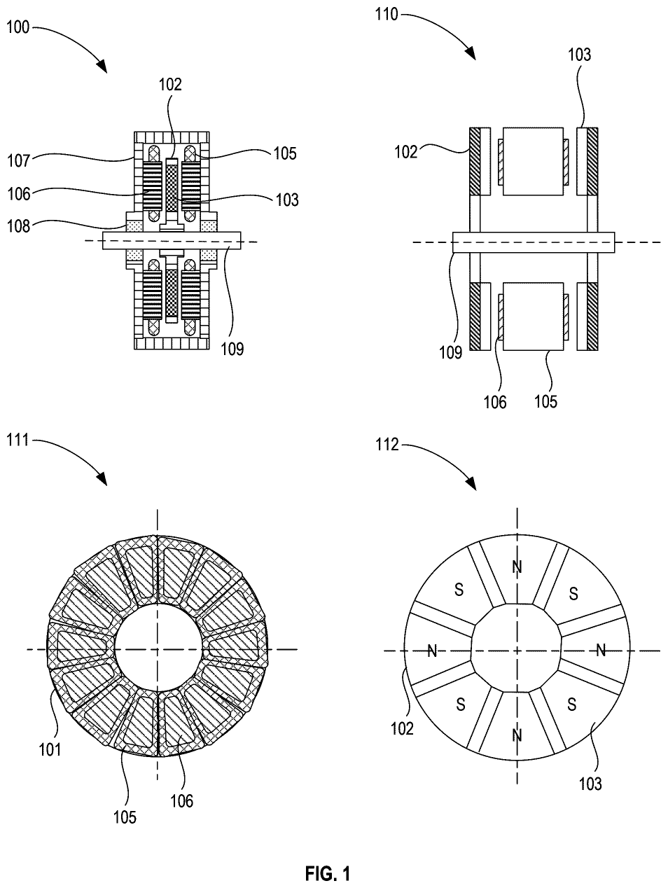

In specific embodiments of the invention, the coiled ribbon of conductive material forms pole piece 401 in FIG. 4 in its entirety. This contrasts with related art axial flux electric machines discussed above in that a conductive material is not coiled around a central structure such as trapezoidal pole pieces 106 as shown in FIG. 1. In this way, the present invention does not require complicated manufacturing processes that accompany the construction of such central structures. Further, the ribbons of conductive material can be coiled into coils of any geometric shape, including, for example, rectangle, circular, triangular, pie, pentagonal, etc. This provides certain benefits in that the pole pieces can be shaped to fit different geometries as required by alternative design constraints for the axial flux electric machine. In specific embodiments, an outline of the coiled ribbon of conductive material forms a polygon as seen in FIG. 5. Furthermore, using these approaches, the soft magnetic material, if present, can be distributed over the entire surface area of the pole piece as opposed to only being present in the center of the pole piece while leaving room for an outer winding as in pole piece 106 in FIG. 1. In specific embodiments, an annulus defined by an innermost turn of the coiled ribbon of conductive material and an outermost turn of the coiled ribbon of conductive material forms at least half of a surface area of the pole piece as measured in the radial direction of the axial flux electric machine. As such, the coiled ribbon of conductive material, and any soft magnetic material which is in the same interleaved composite material coil, can be distributed over the entire surface area of the pole piece. The fact that the soft magnetic material is distributed over a larger portion of the pole piece leads to an increase in the efficiency of the motor. In specific embodiments, the coiled ribbon of conductive material has a diameter of at least half of the surface area of the pole piece as measured in a radial direction of the coiled ribbon of conductive material. In specific embodiments, a radial surface area of the coiled ribbon of conductive material forms at least half of a radial surface area of the pole piece. FIG. 5 illustrates an interleaved composite material coil having a radial surface area that is the entire radial surface area of the pole piece because the entire pole piece is defined by the interleaved composite material coil.

In specific embodiments of the invention, the coil of conductive material forms the pole piece as a free-standing structure. In specific embodiments of the invention, the interleaved composite material coil forms the pole piece as a free-standing structure. As such, the pole pieces do not require a substrate in addition to the ribbons of material that form the pole pieces. For example, interleaved composite material coil 500 may serve as a free-standing structure in that the coiled ribbons are themselves the pole piece and they do not require a substrate for support. As a result, pole pieces formed in accordance with specific embodiments of the invention disclosed herein are not limited by compatibility with any substrate in terms of the type of materials that can be used to form the pole pieces. Additionally, the thickness and width of the ribbons are not constrained by compatibility with what a given substrate will support. This added degree of flexibility represents a significant improvement over approaches in the related art.

In reference to FIG. 5, the interleaved composite material coil 500, in accordance with specific embodiments, has two ends: an outer coil end on the periphery of the coil on its outermost turn and an inner coil end at the center of the coil on its innermost turn. The coiled ribbon of conductive material in the interleaved composite material coil presents an external electrical contact terminal 503 at the outer coil end and an internal electrical contact terminal 502 at the second end. The direction of the bend towards the external electrical contact would be in the opposite direction for a coil that was coiled counter-clockwise and outwardly from a center of the coil.

In specific embodiments, the coiled ribbon of conductive material includes at least two straight sides. For example, the interleaved composite material coil 500 in FIG. 5 includes a coiled ribbon of conductive material that has been shaped to have two straight sides where the straight sides are meant to engage with radial segments of a stator housing.

In specific embodiments, the ribbons disclosed herein can have various dimensions. For example, the coiled ribbon of conductive material may be less than 1 millimeter thick as measured in a radial direction of the coiled ribbon of conductive material. In some embodiments, the coiled ribbon of conductive material may be at least 1 millimeter wide as measured in an axial direction of the coiled ribbon. In specific embodiments, the dimensions of any coiled ribbon of soft magnetic material that is coiled with the coiled ribbon of conductive material can have comparable measurements. In some embodiments, the thickness of the coiled ribbon of soft magnetic material, as measured in a radial direction of the coiled ribbon of soft magnetic material, and the thickness of the coiled ribbon of conductive material, as measured in a radial direction of the coiled ribbon of conductive material, differ significantly. As mentioned previously, the dimensions of the ribbon can be increased to decrease the resistance of the ribbon and decreased to reduce the weight of the axial flux electric machine. Furthermore, the width of the conductive ribbons can be kept small to reduce the impact of eddy currents.

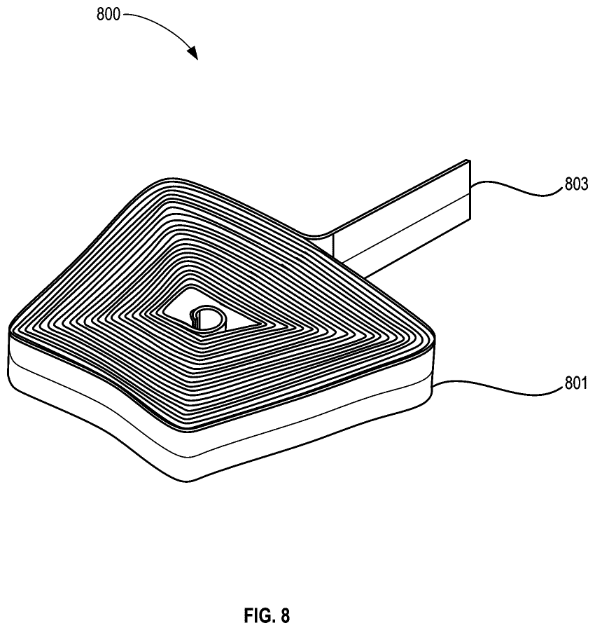

FIG. 8 illustrates a compound interleaved composite material coil 800 which consists of an interleaved composite material coil 801 and a second interleaved composite material coil 803 that can be used to explain specific embodiments of the invention. The two illustrated interleaved composite material coils in FIG. 8 can have similar characteristics to that of interleaved composite material coil 500. For example, interleaved composite material coil 801 can include a coiled ribbon of conductive material and second interleaved composite material coil 803 can include a second coiled ribbon of conductive material. As illustrated, the coiled ribbon of conductive material that is part of interleaved composite material coil 801 is coiled in a first direction (i.e., counter-clockwise) and the second coiled ribbon of conductive material that is part of second interleaved composite material coil 803 is also coiled in the first direction (i.e., counter-clockwise). Furthermore, the second coiled ribbon of conductive material and the coiled ribbon of conductive material are adjacent in the axial direction of the axial flux electric machine. Owing to this configuration, the axial flux of each coiled ribbon of conductive material will be additive. Furthermore, the illustrated approach produces significant benefits in that the combined conductivity of the two coils will be equivalent leading to higher switching speeds while at the same time the width of each individual ribbon has been cut in half compared to a single coil having the same conductivity. This is important because wider ribbons have been shown to produce eddy currents which tend to reduce the switching speed and efficiency of the pole piece. The number of separate coiled ribbons in a compound interleaved composite material coil as in FIG. 8 can be increased substantially above two to increase the benefit of this effect. At the same time, the ribbons can be adhered to adjacent ribbons using an insulative adherent in order for the compound coils to still maintain a structural cumulative width sufficient to serve as a freestanding structure. In the illustrated case, the second coiled ribbon of conductive material and the coiled ribbon of conductive material are each less than 5 centimeters wide as measured in an axial direction of the axial flux electric machine. In specific embodiments of the invention, the number of coiled ribbons of conductive material can be increased to the point where the coiled ribbons of conductive material are instead individual strands of conductive material in a Litz wire.

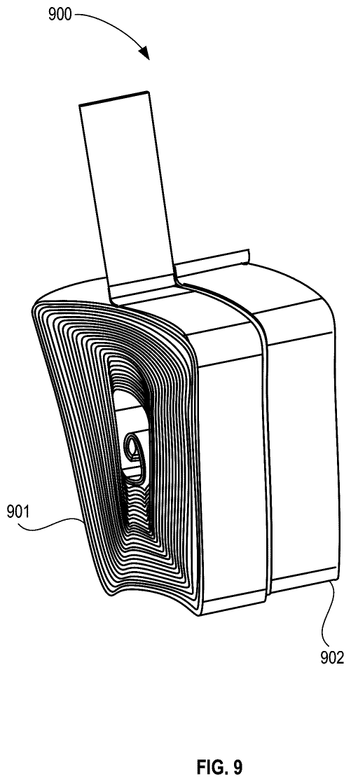

FIG. 9 illustrates an example of an assembled pole piece 900 with a first interleaved composite material coil 901 and a second interleaved composite material coil 902 in accordance with specific embodiments of the invention. The interleaved composite material coils can include coiled ribbons of conductive material. In specific embodiments, each interleaved composite material coil has an external electrical contact terminal and an internal electrical contact terminal. The external electrical contact terminal can be a positive contact terminal or a negative contact terminal depending upon the configuration of the axial electrical machine. Furthermore, the interior electrical contact terminals of different interleaved composite material coils can be coupled together. In the particular configuration illustrated in FIG. 9, the interior electrical contacts of the two coils can be coupled together and one of the external electrical contact terminals can be a positive contact terminal while the other external electrical contact terminal is a negative contact terminal. As illustrated, first interleaved composite material coil 901 is coiled clockwise and inwardly and second interleaved composite material coil 902 is coiled clockwise and outwardly. Accordingly, the two adjacent coils can produce additive magnetic fluxes and also form a continuous electrical circuit from a positive contact terminal to a negative contact terminal with both terminals being located on an exterior of the stator in which assembled pole piece 900 will be installed.

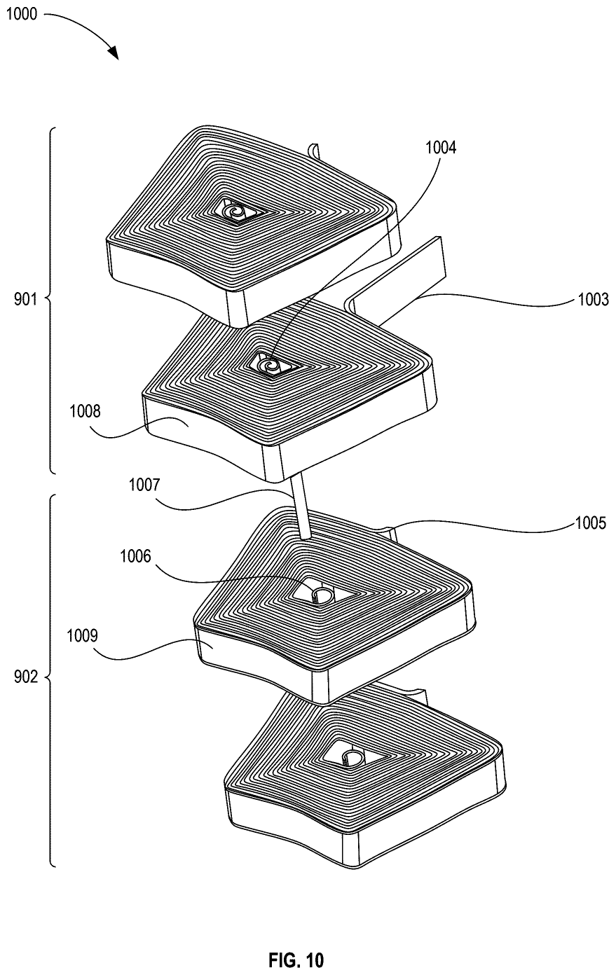

FIG. 10 illustrates an exploded view 1000 of the assembled pole piece 900. The exploded view shows two interleaved composite material coils with each of those composite material coils broken up into the two main coils of material that make up the composite material coils for a total of four coils. The first interleaved composite material coil 901 has an external electrical contact terminal 1003 and an internal electrical contact terminal 1004 on the coiled ribbon of conductive material that is a part of that composite material coil. The second interleaved composite material coil 902 has an external electrical contact terminal 1005 and an internal electrical contact terminal 1006 on the coiled ribbon of conductive material that is a part of that composite material coil. The internal electrical contact terminal 1004 and the internal electrical contact terminal 1006 are each electrically connected to an electrically conductive pin 1007. The conductive pin 1007 contacts an innermost turn of the coiled ribbon and an innermost turn of the second coiled ribbon and forms a part of the conductive path between the two external contact terminals. In this way, the external electrical contact terminal 1003 of the first interleaved composite material coil 901 is ohmically connected to the external electrical contact terminal 1005 of the second interleaved composite material coil 902, forming a conductive pathway between the two external electrical contact terminals.

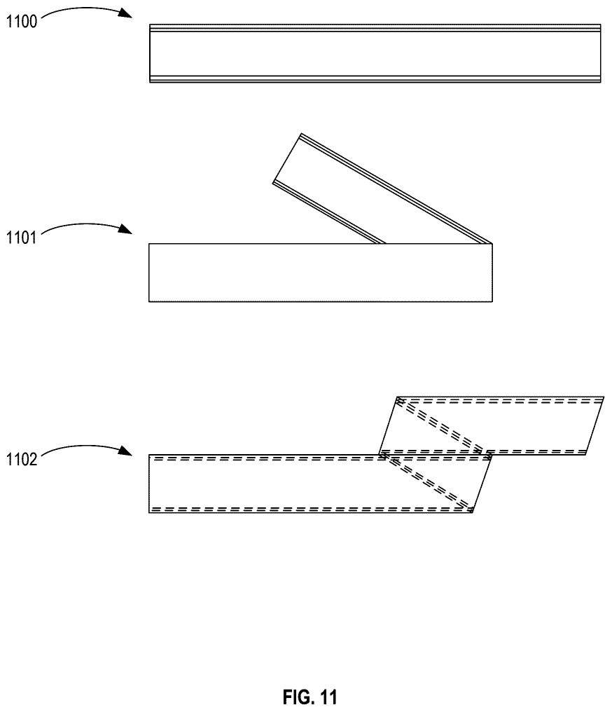

The connection between separate coils of conductive materials that are spaced apart axially in the axial electrical machine can be provided in various ways. In the example of FIGS. 9 and 10, the connection is provided by a conductive pin. In other embodiments, the conductive pathway between the two external electrical contact terminals is formed differently. For example, in alternative embodiments, a single ribbon of conductive material can form both coils as a single piece. Accordingly, an interleaved composite material coil having such a single ribbon of conductive material can inwardly coil from a first external electrical contact terminal towards the center of the pole piece in a first plane, bend from a first plane in which the first coil is located into a second plane in which the second coil is located, and then outwardly coil from the center of the pole piece to a second external electrical contact terminal in the second plane. In other words, a coiled ribbon of conductive material that is in a first interleaved composite material coil (e.g., 1008) and a second coiled ribbon of conductive material that is in a second interleaved composite coil (e.g., 1009) can be part of a single continuous strip of conductive material. The single continuous strip of conductive material can be folded according to the process described below with reference to FIG. 11. Accordingly, in specific embodiments, the conductive path between axially spaced coils can include a fold in such a single continuous strip of conductive material that links the coiled ribbon of conductive material and the second coiled ribbon of conductive material.

FIG. 11 illustrates the process for forming an internal connection in the form of a fold in a single continuous strip of conductive material. In step 1100 the single continuous strip of conductive material can be provided. As shown, the strip of material can be folded over in step 1101 so that the folded portion forms the outline of a right-angle triangle with a top surface of the unfolded original strip of material. Next, the folded portion can then be folded again in step 1102 so that the strip of material is oriented in the same direction on either side of the fold. The position of the fold in step 1102 can be selected so that there is a sufficient offset between the plane occupied by the original unbent side of the strip of material and the bent side of the strip of material so that the two planes occupied thereby are sufficiently spaced for the coils of the pole piece to be formed. Since the strip of material is oriented in the same direction on either side of the fold, the coils formed on either side of the fold will be coiled in the same direction and their magnetic flux will be additive.

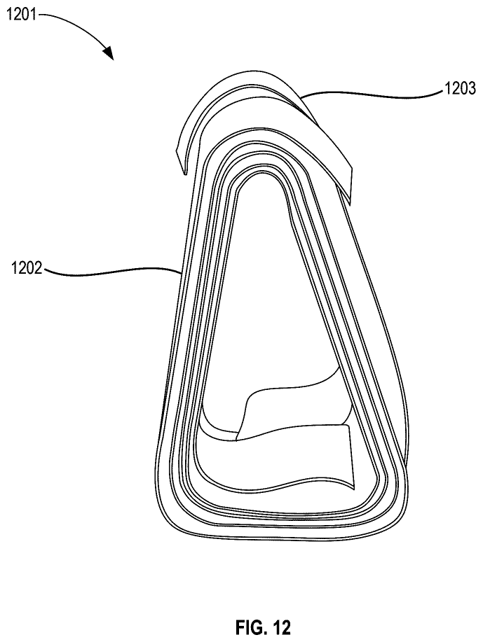

FIG. 12 illustrates a pole piece 1201 that has been formed using this approach illustrated in FIG. 11, two interleaved composite material coils have been formed by a single continuous strip of conductive material and a single continuous strip of soft magnetic material with both strips of material being folded according to the process in FIG. 11. As illustrated, the pole piece includes two external electrical contacts and the two coils are oriented such that their magnetic flux is additive (i.e., both coils are coiled counter-clockwise with coil 1202 coiling inward and coil 1203 coiling outward).

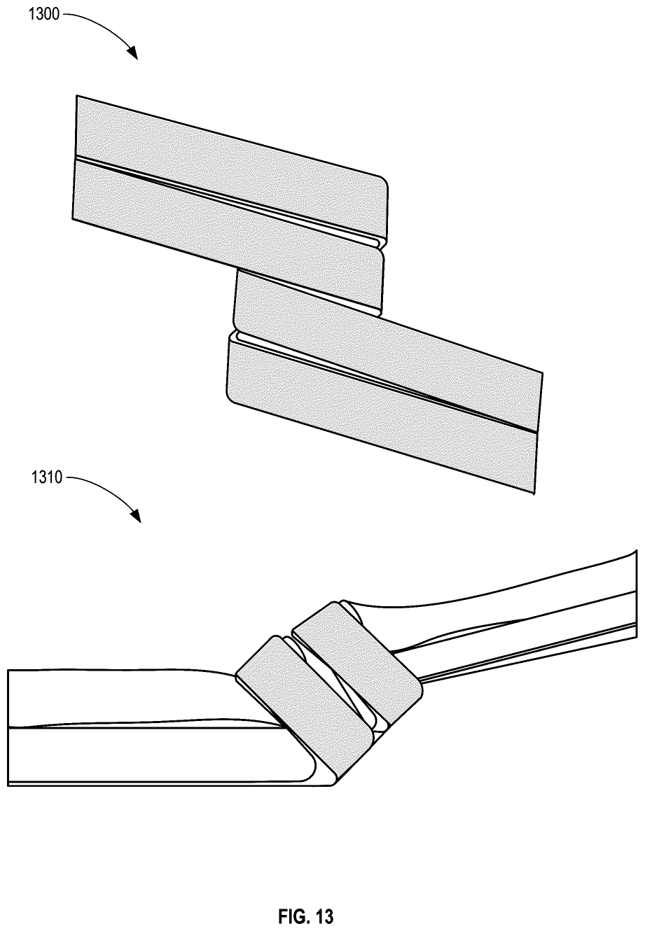

FIG. 13 illustrates a fold pattern to allow a set of compound coils to utilize an internal electrical connection in the form of the folds described with reference to FIGS. 11 and 12. The compound coil can be the compound coil described with reference to FIG. 8 and it can include an internal connection in order to be connected to another compound coil where the two compound coils are oriented as the coils are with reference to FIGS. 9 and 10. View 1300 shows a top down view of the fold and view 1310 shows a bottom up view of the fold. As illustrated, two single ribbons of conductive material and two single ribbons of soft magnetic material are folded such that they can form a compound coil, transfer into a different plane, and then form a second compound coil. As the strips of material are oriented in the same direction on either side of the fold, both compound coils will coil in the same direction and can have additive magnetic flux. At the same time, one compound coil can coil inward and the other compound coil can coil outward such that a pole piece formed by the two compound coils can have two external electrical connections.

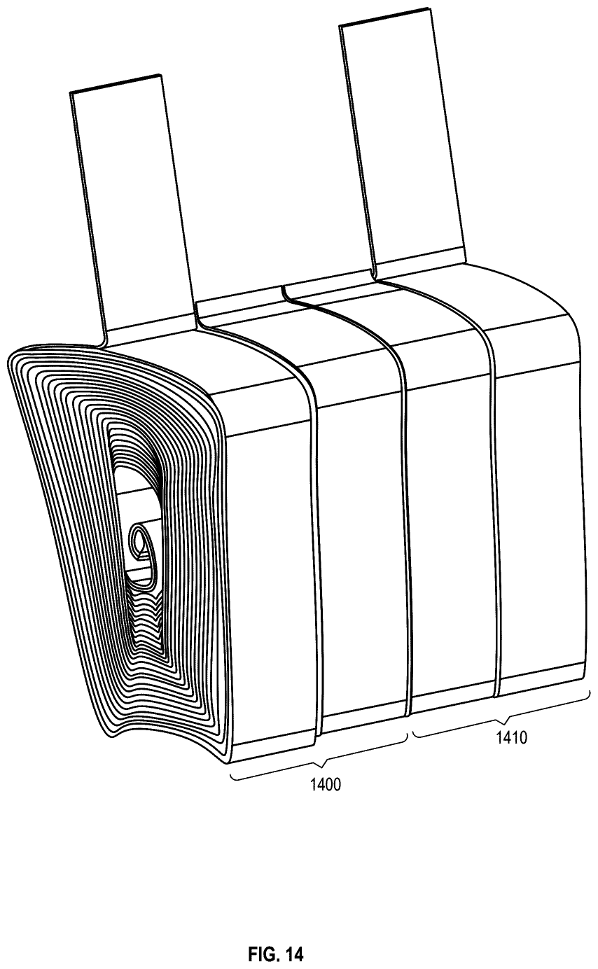

FIG. 14 illustrates a set of pairs of coils that are arranged so that the coils all have additive magnetic fluxes and each pair of coils forms a single conductive pathway into the center of the coil and back out to the exterior of the coil to thereby present both a positive contact terminal and a negative contact terminal on an exterior of the coil. The set of pairs of coils could form a pole piece for an axial flux electric machine in accordance with this disclosure. While FIG. 14 includes two pairs of coils shown by pair 1400 and pair 1410, a set of pairs of coils in accordance with this disclosure could include any number of pairs of coils in the set so long as the illustrated pattern was continued. For example, the set of pairs that form a pole piece could include 2, 3, or 4 pairs of coils. The individual coils in the pairs could also be compound coils as described with reference to FIG. 8.

The pattern shown in FIG. 14 includes a coiled ribbon of conductive material coiled inwardly in a first direction and at least one additional coiled ribbon of conductive material coiled in the first direction (e.g., the outer coil of pair 1400 and the outer coil of pair 1410), and a second coiled ribbon of conductive material coiled in a second direction and at least one additional coiled ribbon of conductive material coiled in the second direction (e.g., the inner coil of pair 1400 and the inner coil of pair 1410), where the at least one additional coiled ribbon of conductive material coiled in the first direction and the at least one additional coiled ribbon of conductive material coiled in the second direction are arranged adjacently in the axial direction of the axial flux electric machine such that the magnetic fluxes of the coiled ribbon of conductive material, the second coiled ribbon of conductive material, the at least one additional coiled ribbon of conductive material coiled in the first direction, and the at least one additional coiled ribbon of conductive material coiled in the second direction are additive. Patterns in accordance with this disclosure can also be described with reference to the inward or outward coiling of the coils and the direction of the coils. In the pattern, each coil would coil in the same direction and A coils coil inwardly while B coils coil outwardly or vice versa. Accordingly, the pattern would be AB-BA-AB-BA with the pattern continuing as many times as needed to form a pole piece with the constraints of the overall axial machine in place such as minimizing the weight of the axial flux electric machine and other constraints.

In specific embodiments of the invention, an axial flux electric machine comprises a first pair of coiled ribbons of conductive material. For example, the coiled ribbon of conductive material and second coiled ribbon of conductive material described with reference to FIG. 9 can form the first pair of coiled ribbons of conductive material. The first pair of coiled ribbons of conductive material can be those of pair 1400. The axial flux electric machine can comprise at least one additional pair of coiled ribbons of conductive material, such as pair 1410, wherein the at least one additional pair of coiled ribbons of conductive material and the first pair of coiled ribbons of conductive material form a set of pairs of coiled ribbons of conductive material. As illustrated, every coiled ribbon of conductive material in the set of pairs of coiled ribbons of conductive material is coiled in a first direction, each pair of coiled ribbons of conductive material in the set of pairs of coiled ribbons of conductive material has an inwardly coiled coil and an outwardly coiled coil, and the set of pairs of coiled ribbons of conductive material are arranged adjacently in the axial direction of the axial flux electric machine so that an inwardly coiled coil of one pair is never adjacent to an outwardly coiled coil of another pair. Using this approach, the coils are all additive in terms of their magnetic flux, and each pair of coils provides two external electrical contacts. The pairs of coils can share a common conductive connection at their internal contacts such as a common conductive pin.

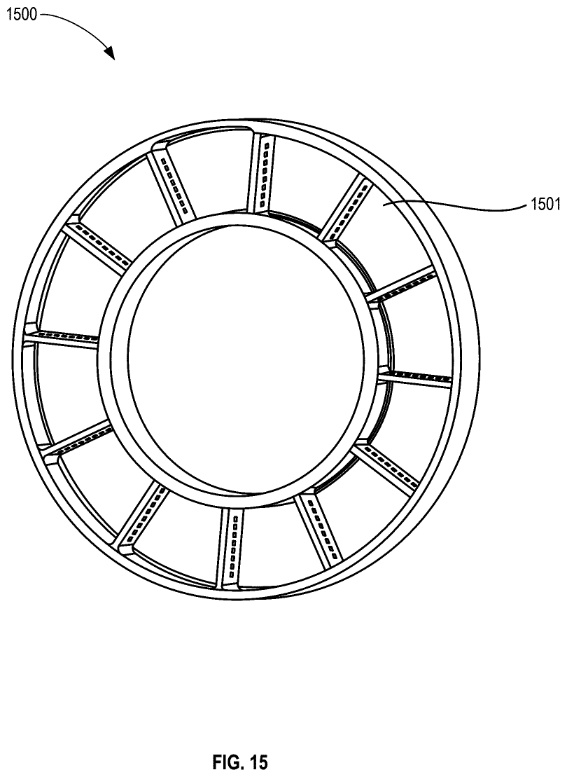

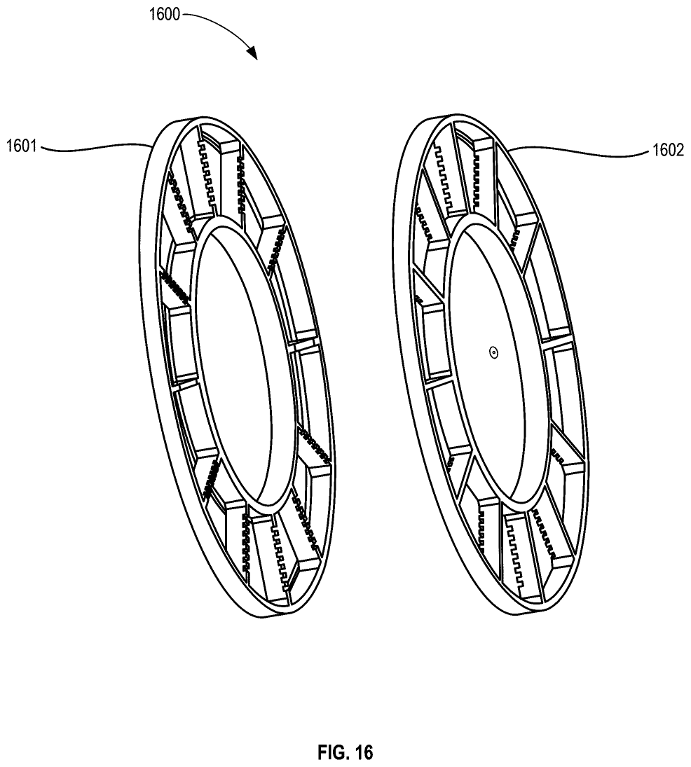

FIG. 15 illustrates an example of a stator housing 1500 for assembling and housing pole pieces within a stator in accordance with specific embodiments of the invention. The stator housing comprises a set of pole piece compartments 1501. The shape of the pole piece compartments in FIG. 15 is not a limitation of the embodiments of the invention disclosed herein. Indeed, a benefit of using specific embodiments of the invention disclosed herein is that the ribbons can be shaped to form pole pieces of highly variant sizes such that they can accommodate a diverse array of pole piece compartment designs. In other embodiments, a stator housing 1600 can be formed by joining together a first stator housing 1601 and a second stator housing 1602 as shown in FIG. 16. The stator housings may be manufactured using primarily metallic, polymer, or composite with separate parts that are mechanically joined together using one of known joining methods such as adhesion, fasteners, rivets, or other. Pole pieces are attached to the stator housing and fitted to pole piece compartments: one pole piece in one pole piece compartment. FIG. 4 illustrates a view of one side of the stator where pole pieces are thusly assembled. In specific embodiments, the stator housing is over-molded on the pole pieces.

As discussed in connection with FIG. 9, each assembled pole piece 900 comprises two interleaved composite material coils 901, 902. In specific embodiments, each pole piece is electrically connected to electrically conducting busbars not depicted in this figure through the two external electrical contact terminals 1003, 1005 of the pole piece. In this way, all pole pieces of that stator are connected through busbars. In turn, the busbars are electrically connected to the stator's electrical contact terminals 402, 403, 404. In some embodiments, some or all of the external electrical contact terminals of the pole pieces or the electrical contact terminals of the stator are positioned along the outer diameter of the stator. For example, in FIG. 4, the electrical contact terminals of the stator are positioned along the outer diameter of the stator. In some embodiments, some or all external electrical contact terminals of the pole pieces or the electrical contact terminals of the stator are positioned along the inner diameter of the stator.

In a pole piece assembled within the stator as discussed above, the pole piece's first interleaved composite material coil 901 and second interleaved composite material coil 902 are separated by a small gap that ensures the electrically conductive coils maintain a minimum distance to avoid any electrical breakdown of air due to electrical potential developed during operation. Alternatively, the gap is filled with a dielectric oil that enhances dielectric strength of the gap and allows for a narrower gap. Alternatively, a dielectric oil flows through the gap and allows for heat transfer from the coils to an external heat sink. This is achieved by connecting the oil flow path to a pump that maintains the flow of dielectric oil within the gap between the first interleaved composite material coil 901 and the second interleaved composite material coil 902.

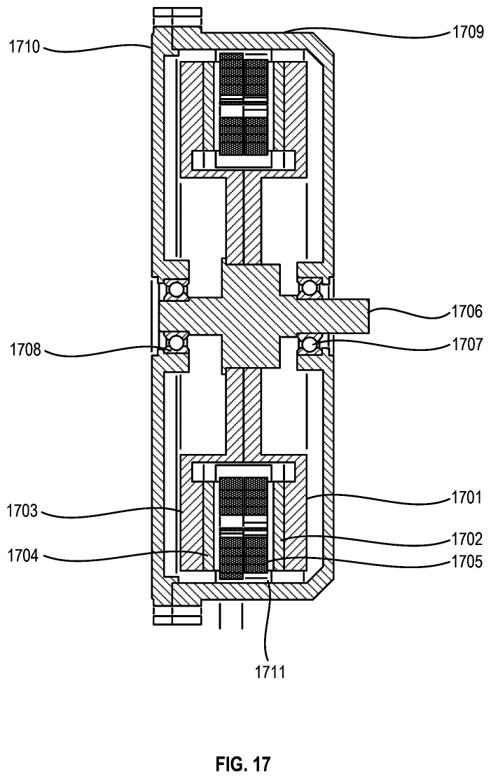

FIG. 17 illustrates a cross-sectional view of the axial flux electric machine of FIG. 2 where various components of the machine as described above have been assembled. FIG. 17 shows rotor support structure 1701 and permanent magnet disc 1702 of a first portion of a rotor on one side of the stator, rotor support structure 1703 and permanent magnet disc 1704 of a second portion of a rotor on the other side of the stator opposite to the first portion of the rotor, a pole piece 1705, a rotor shaft 1706, rotor support bearings 1707, 1708, and an external housing comprising external housing parts 1709, 1710. The stator is secured to the housing via stator support structure 1711. The portions of the axial flux electric machine above the rotor shaft 1706 with similar shading are alternative parts of the same circular components.

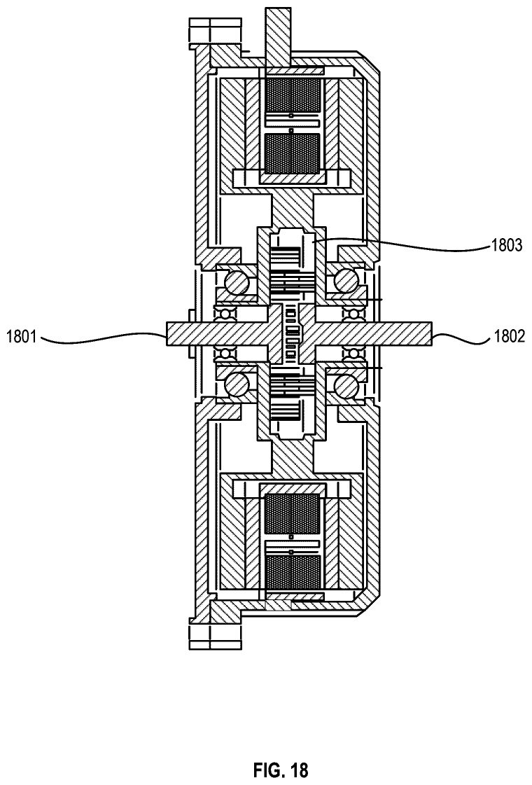

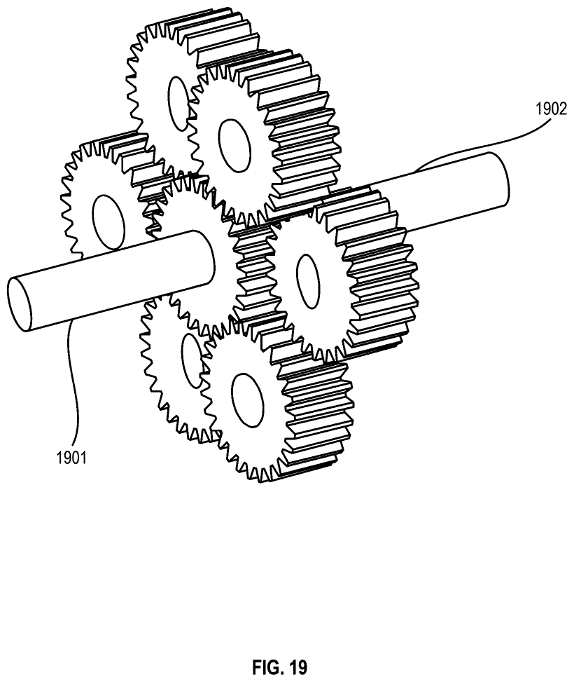

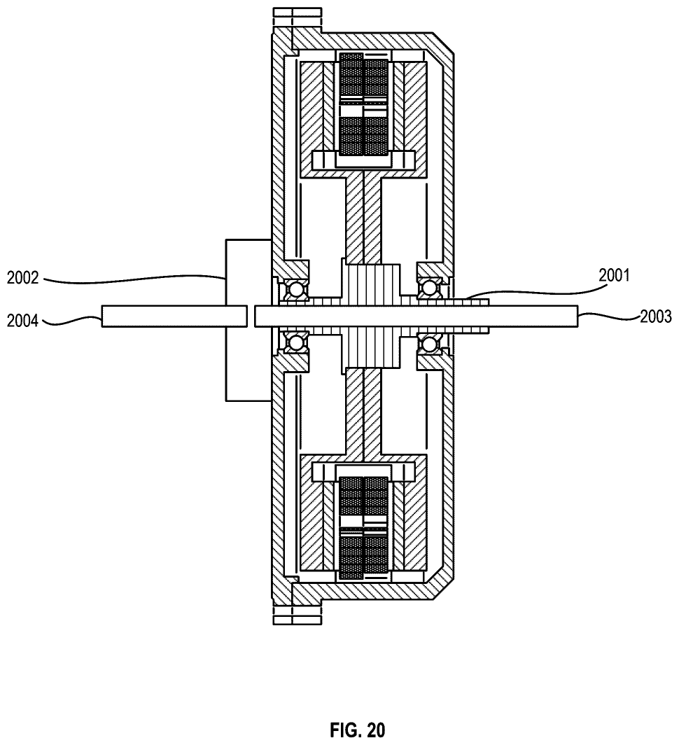

FIG. 18 illustrates a cross-sectional view of a specific embodiment of the axial flux electric machine which comprises a first rotor shaft 1801, a second rotor shaft 1802, and a mechanical differential assembly 1803. The mechanical differential assembly transmits torque from the rotors to the rotor shafts and using gears, pinion gears, and other components, allows for a rotational difference between the two rotor shafts. The allowance for the rotational differences allow relative rotational motion of the two rotor shafts. FIG. 19 illustrates an example of gears of the mechanical differential assembly with the two shafts 1901, 1902 and the associated gears. In FIG. 18, the mechanical differential assembly 1803 is located inside the axial flux electric machine. In an alternative embodiment, the differential mechanical assembly can be located outside the machine. In such an embodiment, as illustrated in FIG. 20, the rotors are coupled to a main rotor shaft 2001 that is hollow, differential assembly 2002 is located immediately outside the axial flux electric machine, and one of the rotor shafts passes through the hollow main shaft from one side of the machine to the differential assembly located on the other side of the machine. The differential assembly 2002 transfers torque from the main rotor shaft to a first rotor shaft 2003, which passes through the hollow main shaft, and a second rotor shaft 2004, by using gears and pinion gears and other components, causes a rotational difference between the two rotor shafts.

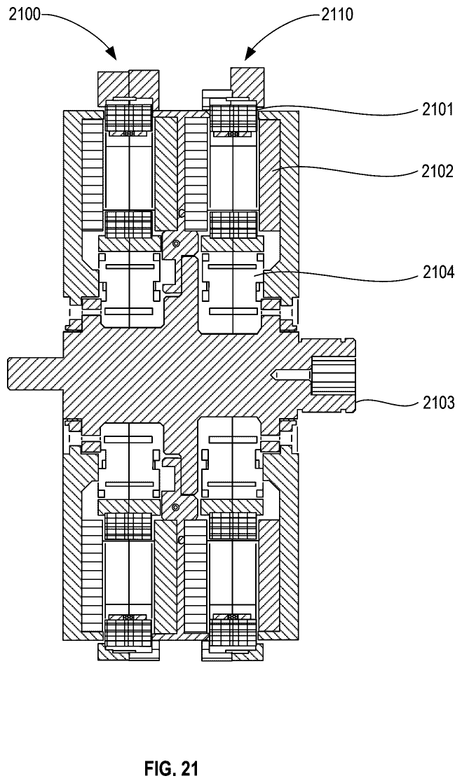

In specific embodiments of the invention, two or more axial flux electric machines as described above can be axially stacked and form a single motor assembly. The two motors can be connected to a common rotor shaft or be connected to separate rotor shafts. FIG. 21 illustrates an axial flux electric machine with two axial flux electric machines 2100, 2110 that form a single motor assembly. The motor assembly includes two stators, each comprising a plurality of composite coils 2101 with rotors having permanent magnets 2102. The two rotors are connected to rotor shaft 2103 via rotor supports 2104. In alternative embodiments, the two rotors can be connected to different rotor shafts. In the illustrated embodiment, the two stators may be electrically connected, or they may be powered by entirely separate circuits.

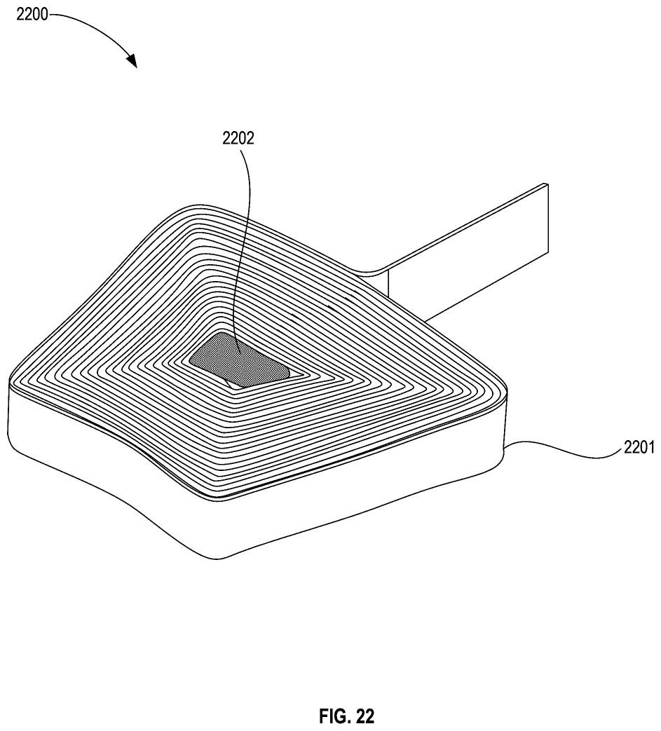

FIG. 22 illustrates an example of coil 2200 with soft magnetic core 2202 in accordance with specific embodiments of the invention. Coil 2200 is formed by coiling a ribbon 2201 inwardly and counterclockwise (i.e., counterclockwise from the outside of the coil to the inside of the coil). When installed, the coil's axial direction will be substantially parallel to the axial direction of the axial flux electric machine. Ribbon 2201 may be a composite material ribbon that is formed by interleaving a ribbon of soft magnetic material and a ribbon of conductive material. In specific embodiments, the composite material ribbon may also include one or more ribbons of insulative material. Instead of separate ribbons of material, the insulative material could be a part of the ribbon of conductive material, part of the ribbon of soft magnetic material, or both. In specific embodiments, the ribbon of conductive material may be sheathed in, or coated with, an insulative material. The sheathing could be partial because the ends of the will need to have an ohmic connections to a bias voltage source. However, within the coil, all sides of the ribbon could be sheathed in insulative material.

Soft magnetic core 2202 (e.g., soft magnetic core material) may be located within an innermost turn of coil 2200. Soft magnetic core 2202 may extend from one side of the innermost turn to an opposite side of the innermost turn of the coil. The material for soft magnetic core 2202 can be one of iron, silicon steel, magnetic cobalt alloy, amorphous steel, and any other suitable material. The material for soft magnetic core 2202 may be the same as, or different than, the material for the ribbon of soft magnetic material (e.g., in ribbon 2201). The insulative material could be part of the ribbon in that it sheathes at least a portion of the conductive material or the soft magnetic material.

The soft magnetic material (e.g., both the core and the ribbon) may allow the device to be configurably magnetized under the influence of current applied to the coiled wire. Soft magnetic core 2202 bolsters torque by 15% as compared to an equivalent pole piece in which the coil continues all the way to the center as in FIG. 5. In specific embodiments, a soft magnetic core may reduce torque rippling and hence may reduce noise and vibration. Soft magnetic core 2202 may be wider in the axial direction than ribbon 2201. Soft magnetic core may be wider in the axial direction than a conductive portion of ribbon 2201 (e.g., a portion made of at least one ribbon of conductive material). If the ribbon 2201 is composed of multiple ribbons of conductive material, soft magnetic core 2202 may be wider in the axial direction than the collective width of the set of multiple ribbons of conductive material. Soft magnetic core 2202 may be wider or thinner in an axial direction than a ribbon of insulative material within ribbon 2201.

Soft magnetic core 2202 may enable a gradual fold architecture between two axially adjacent coils of a pole piece. For example, the soft magnetic core may allow a coil to have less turns. Fewer turns means that the coil may not go as far toward the center of the coil, allowing space for the gradual fold. Because the coil includes enough space in the center for the soft magnetic core, there may also be sufficient space for the gradual fold.

The addition of the soft magnetic core piece reduces the magnetic reluctance in the path of the magnet flux leading to a higher flux density across the airgap. The addition of soft magnetic core also reduces the leakage flux, helping the magnet flux to link more effectively with the stator flux. Therefore, the coil with the soft magnetic core creates higher flux density across the airgap surface area, which results in higher torque. In addition, the soft magnetic core reduces the cogging torque and the torque ripple of the motor.

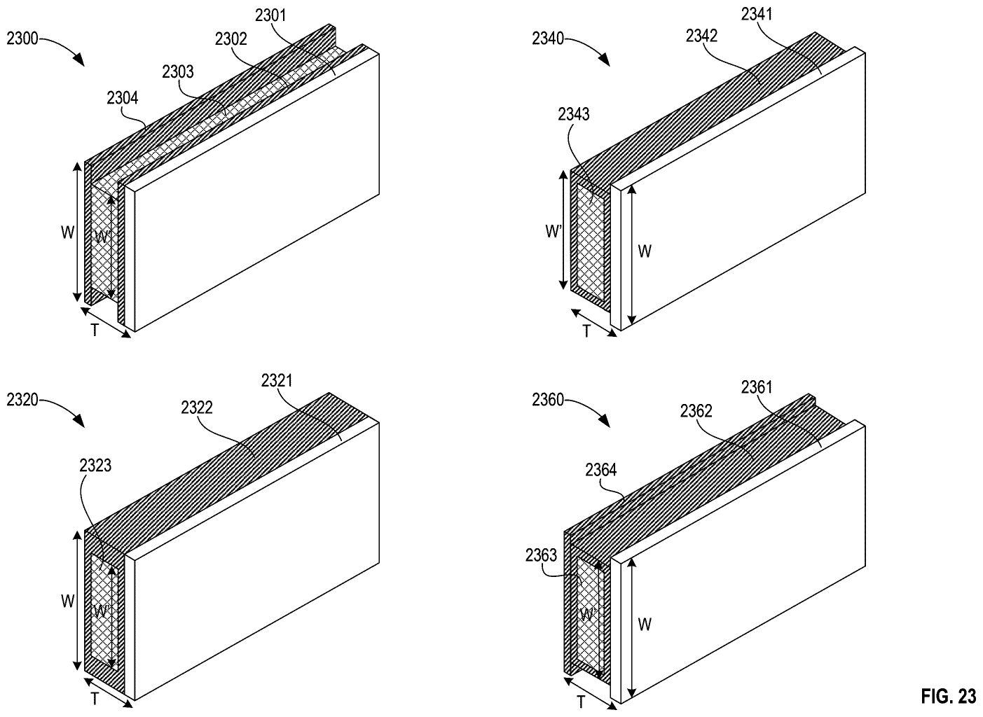

FIG. 23 illustrates examples of pieces of composite material ribbons with insulative material in accordance with specific embodiments of the invention. The composite material ribbons may each form coils in a pole piece of a stator. FIG. 23 shows pieces of composite material ribbons 2300, 2320, 2340, and 2360 made of combinations of ribbons of insulative material, soft magnetic material, and conductive material. A coiled ribbon of insulative material, a coiled ribbon of conductive material, and a coiled ribbon of soft magnetic material may be commonly coiled in an interleaved composite material coil. The ribbon of conductive material may be in contact with insulative material (e.g., either as a separate ribbon of insulative material or as a coating or sheath of insulative material). The insulative material may isolate the coiled ribbon of conductive material from the coiled ribbon of soft magnetic material. The insulative material may be an insulative tape. The material for the ribbon of soft magnetic material can be one of iron, silicon steel, magnetic cobalt alloy, amorphous steel, and any other suitable material. The material for the ribbon of conductive material can be one of copper, aluminum, and any other suitable material. Instead of separate ribbons of material, the insulative material could be a part of the ribbon of conductive material, part of the ribbon of soft magnetic material, or both. The insulative material could be part of the ribbon in that it sheathes at least a portion of the conductive material or the soft magnetic material. The sheathing could be partial because the ends of the ribbon of conductive material will need to have ohmic connections to a bias voltage source. However, within the coil, all sides of the ribbon could be sheathed in insulative material. In specific embodiments, not all sides of the ribbon of conductive material may be coated, for example only the two sides with larger surface areas (e.g., the left and right sides shown in FIG. 23, radial sides) may be coated while the other two sides (e.g., the top and bottom sides shown in FIG. 23) may not be coated.

As shown in FIG. 23, each ribbon of a particular material in each composite ribbon has two cross-sectional straight sides: W, the width of the ribbon as measured in an axial direction of the interleaved composite material coil, and T, the thickness of the ribbon as measured in a radial direction of the interleaved composite material coil. The composite material ribbon can include multiple ribbons of the same material. For example, two ribbons of conductive material can be pressed together in the composite material ribbon. This has the beneficial effect of doubling the thickness of the conductive material and thereby decreasing by half (assuming all other factors are constant) the ohmic resistance of the conductive material. This is particularly beneficial, because when, during operation, the interleaved composite material coil is energized, the pole of its magnetic flux alternates and the lower the resistance through the conductive material, the faster the pole changes. In this way, the thickness of the coiled ribbon of the conductive material and therefore, the performance of the axial flux electric machine are easily adjustable: the larger the ribbon thickness, the lower the resistance, and the faster the pole switching rate. Conversely, the smaller the ribbon thickness, the higher the resistance, and the slower the pole switching rate. However, increasing the thickness of the coiled ribbon of the conductive material in this manner adds more weight to the machine and increases manufacturing cost. Additionally, a thicker ribbon may alter the number of coil turns that fit within a pole piece footprint. An appropriate design thickness of the ribbon can be determined as a trade-off among weight, manufacturing cost, and performance.

The widths and thicknesses of components of the composite ribbons may be different from each other. For example, the width of the ribbons of conductive material may be less wide than that of other ribbons. This difference may accommodate for stacking composite coils in an axial direction without allowing conductive paths between adjacent coils via their ribbons of conductive material. The ribbons of conductive material may be less wide than other ribbons even if the conductive material is sheathed in an insulative material to accommodate for imperfections in the insulative coating. Ribbons of conductive material may be at least partially sheathed by an insulative material.

Composite material ribbon 2300 may be formed by interleaving, from the right to the left, a ribbon of soft magnetic material 2301, a ribbon of insulative material 2302, a ribbon of conductive material 2303, and a second ribbon of insulative material 2304—such that on each side of the ribbon of conductive material there is one ribbon of insulative material. Ribbon of conductive material 2303 may be less wide than ribbon of soft magnetic material 2301 and ribbons of insulative material 2302 and 2304. Coiled ribbon of insulative material 2302 (or 2304) may have a width W in the axial direction of the axial flux electric machine. Coiled ribbon of conductive material 2303 may have a width W′ in the axial direction of the axial flux electric machine. W may be larger W′. Insulative material 2304 may be on the side of the ribbon of conductive material 2303 in a radial direction of the pole piece. Insulative material 2302 may be on the other side of the ribbon of conductive material 2303 in the radial direction of the pole piece.

Composite material ribbon 2320 may be formed by interleaving a ribbon of soft magnetic material 2321 and a sheathed ribbon of conductive material 2323. Sheathed ribbon of conductive material 2323 may be coated with insulative material 2322. The conductive portion of sheathed ribbon of conductive material 2323 may be less wide than ribbon of soft magnetic material 2321. Coiled ribbon of soft magnetic material may have a width W in the axial direction of the axial flux electric machine. The conductive portion of sheathed coiled ribbon of conductive material 2323 may have a width W′ in the axial direction of the axial flux electric machine. W may be larger W′.

Composite material ribbon 2340 may be formed by interleaving a ribbon of soft magnetic material 2341 and a sheathed ribbon of conductive material 2343. Sheathed ribbon of conductive material 2343 may be coated with insulative material 2342. Sheathed ribbon of conductive material 2343, including the insulative coating, may be less wide than ribbon of soft magnetic material 2341. Coiled ribbon of soft magnetic material 2341 may have a width W in the axial direction of the axial flux electric machine. Sheathed coiled ribbon of conductive material 2343, with insulative material 2342, may have a width W′ in the axial direction of the axial flux electric machine. W may be larger W′.

Composite material ribbon 2360 may be formed by interleaving a ribbon of soft magnetic material 2361, a sheathed ribbon of conductive material 2363, and a ribbon of insulative material 2364. Sheathed ribbon of conductive material 2363 may be coated with insulative material 2362. Sheathed ribbon of conductive material 2363, including the insulative coating, may be less wide than ribbon of soft magnetic material 2361 of ribbon of insulative material 2364. Coiled ribbon of soft magnetic material 2361 and ribbon of soft magnetic material 2361 of ribbon of insulative material 2364 may each have a width W in the axial direction of the axial flux electric machine. Sheathed coiled ribbon of conductive material 2363, with insulative material 2362, may have a width W′ in the axial direction of the axial flux electric machine. W may be larger W′. Insulative material 2364 may be on the side of the ribbon of conductive material 2363 in a radial direction of the pole piece. In specific embodiments, another insulative material may be on the other side of the ribbon of conductive material 2363 in the radial direction of the pole piece.

Although shown as next to sheathed ribbon of conductive material 2363, ribbon of insulative material 2364 may be along the illustrated exposed side of the ribbon of soft magnetic material 2361, or between ribbon of soft magnetic material 2361 and sheathed ribbon of conductive material 2363. In specific embodiments, a composite ribbon may have multiple ribbons of insulative material as well as an insulative sheath or coating on the ribbon of conductive material. Additionally, although ribbon of soft magnetic material 2361 and ribbon of soft magnetic material 2361 of ribbon of insulative material 2364 are each shown to have a width W, these widths may be different from each other in other embodiments. In specific embodiments, an insulative tape may form all or part of an insulative sheath of a ribbon of conductive material.

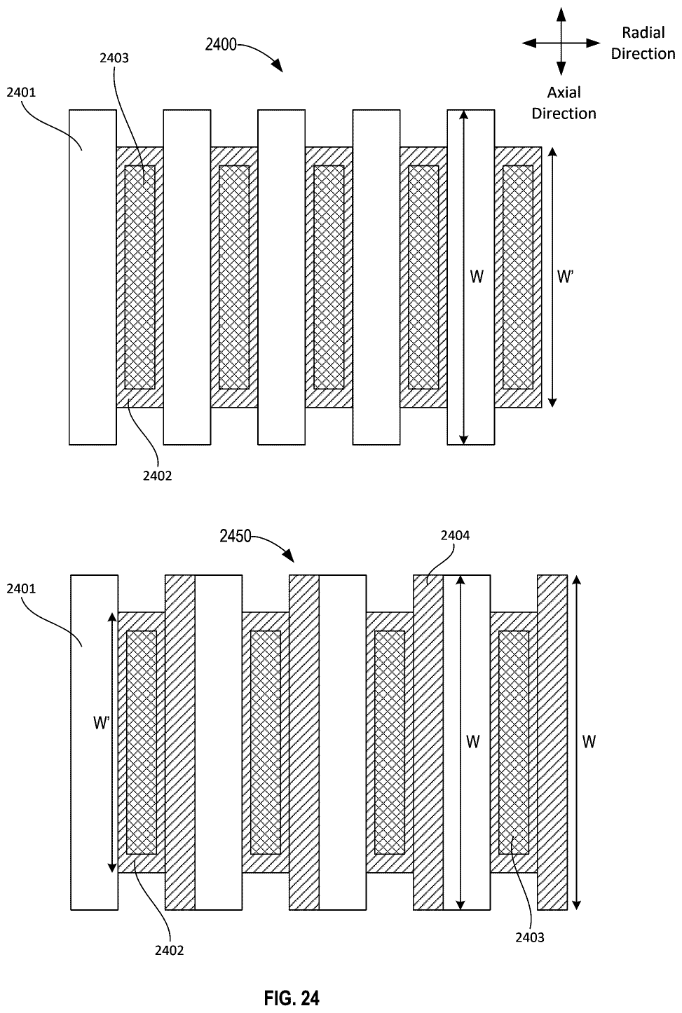

FIG. 24 illustrates cross sections of examples of coils with insulative material in accordance with specific embodiments of the invention. The coils may be made of composite material ribbons. FIG. 24 shows pieces of coils 2400 and 2450 made of a ribbon of soft magnetic material 2401 and a ribbon of conductive material 2403. Coil 2450 also includes ribbon of insulative material 2404. In the example of FIG. 24, ribbon of conductive material 2403 is coated with insulative sheath 2402; however, in specific embodiments, the insulative sheath may be absent. The ribbon of conductive material may be in contact with insulative material (e.g., either as a separate ribbon of insulative material or as a coating of insulative material). Insulative sheaths may be complete or partial. For example, not all sides of the ribbon of conductive material may be coated. The insulative material may be an insulative tape.

As shown in FIG. 24, each ribbon of a particular material in each coil has a width W, as measured in an axial direction of the interleaved composite material coil. The widths and thicknesses of the ribbons (as measured in a radial direction of the interleaved composite material coil) of the ribbons may not be to scale. The widths and thicknesses of components of the composite ribbon may be different from each other. For example, the width of the ribbons of conductive material may be less wide than that of other ribbons. The composite material ribbon can include multiple ribbons of the same material, but each grouping of material is shown as a single ribbon in FIG. 24 for simplicity.

Coil 2400 shows insulative material as a sheath or coating on ribbon of conductive material. Coil 2400 may be formed by interleaving a ribbon of soft magnetic material 2401 and a sheathed ribbon of conductive material 2403. Sheathed ribbon of conductive material 2403 may be coated with insulative sheath 2402. Sheathed ribbon of conductive material 2403, including the insulative coating, may be less wide than ribbon of soft magnetic material 2401. Coiled ribbon of soft magnetic material 2341 may have a width W in the axial direction of the axial flux electric machine. Sheathed coiled ribbon of conductive material 2343, with insulative material 2342, may have a width W′ in the axial direction of the axial flux electric machine. W may be larger W′.

Coil 2450 shows a separate ribbon of insulative material 2404 in addition to the sheath of insulative sheath 2402 around ribbon of conductive material 2403. Coil 2450 may be formed by interleaving a ribbon of soft magnetic material 2401, a sheathed ribbon of conductive material 2403, and a ribbon of insulative material 2404. Sheathed ribbon of conductive material 2403 may be coated with insulative sheath 2402. Sheathed ribbon of conductive material 2403, including the insulative coating, may be less wide than ribbon of soft magnetic material 2401 of ribbon of insulative material 2404. Coiled ribbon of soft magnetic material 2401 and ribbon of insulative material 2404 may each have a width W in the axial direction of the axial flux electric machine. Sheathed coiled ribbon of conductive material 2403, with insulative sheath 2402, may have a width W′ in the axial direction of the axial flux electric machine. W may be larger W′.

In specific embodiments, a composite ribbon may have multiple ribbons of insulative material as well as an insulative sheath or coating on the ribbon of conductive material. For example, a ribbon of insulative material may be interleaved into the composite coil on the other side of the sheathed ribbon of conductive material instead of, or in addition to, ribbon of insulative material 2404. Additionally, ribbon of soft magnetic material 2401 and ribbon of insulative material 2404 may have different widths. These different widths may each be wider than the width of ribbon of conductive material 2403, with or without insulative sheath 2402.

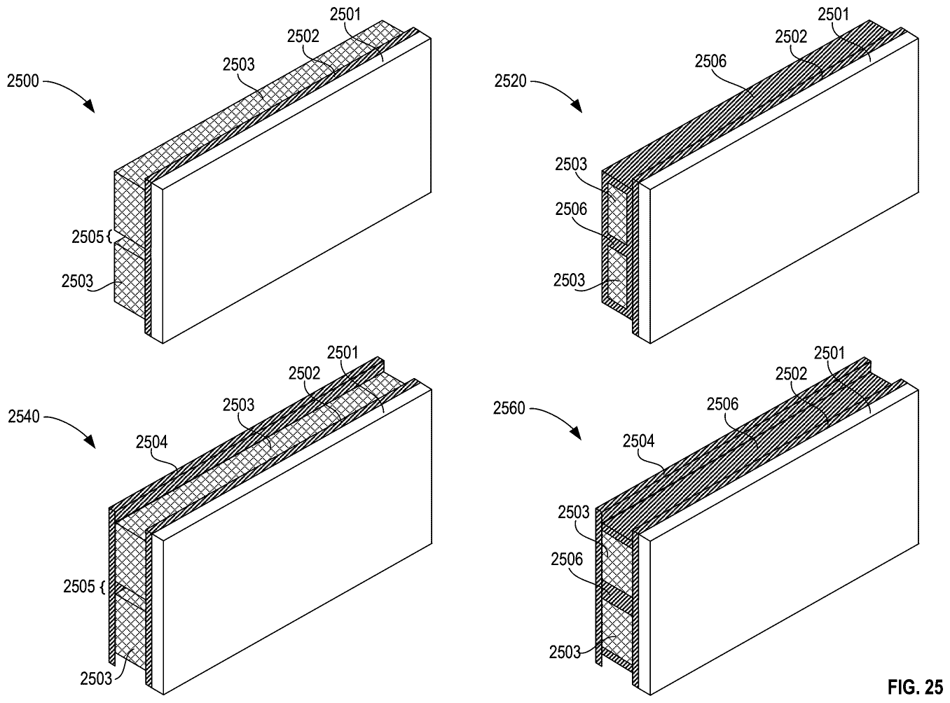

FIG. 25 illustrates examples of pieces of composite material ribbons with multiple ribbons of conductive material in accordance with specific embodiments of the invention. FIG. 25 shows pieces of composite material ribbons 2500, 2520, 2540, and 2560. These composite material ribbons may be made of combinations of ribbons soft magnetic material 2501, ribbons of insulative material 2502, ribbons of conductive material 2503, ribbons of insulative material 2504, and sheathing of insulative material 2506. Ribbon of insulative material 2502 may be on a side of ribbons of conductive material 2303 in a radial direction of the pole piece. Ribbon of insulative material 2504 may be on a side of ribbons of conductive material 2303 in the other radial direction of the pole piece. Although two ribbons of conductive material 2503 are shown in each composite material ribbon, there may be any quantity of ribbons of conductive material within a composite material ribbon. For example, a composite material ribbon may be split into five ribbons of conductive material that are adjacent in the axial direction of the pole piece. Composite material ribbons 2500, 2520, 2540, and 2560 are examples only, as other combinations of the materials described may also produce functional composite material ribbons.

Composite material ribbon 2500 includes ribbon of soft magnetic material 2501, ribbon of insulative material 2502, and ribbons of conductive material 2503. Gap 2505 shows that ribbons of conductive material 2503 are electrically isolated from each other.

Composite material ribbon 2520 includes ribbon of soft magnetic material 2501, ribbon of insulative material 2502, ribbons of conductive material 2503, and sheathing of insulative material 2506. Sheathing of insulative material 2506 electrically isolates ribbons of conductive material 2503 from each other.

Composite material ribbon 2540 includes ribbon of soft magnetic material 2501, ribbon of insulative material 2502, ribbons of conductive material 2503, and ribbon of insulative material 2504. Gap 2505 shows that ribbons of conductive material 2503 are electrically isolated from each other.

Composite material ribbon 2560 includes ribbon of soft magnetic material 2501, ribbon of insulative material 2502, ribbons of conductive material 2503, ribbon of insulative material 2504, and sheathing of insulative material 2506. Sheathing of insulative material 2506 electrically isolates ribbons of conductive material 2503 from each other.

Composite material ribbons 2500 and 2520 may be for lower voltage applications. For lower voltage application, ribbon of insulative material 2502 (e.g., tape) may primarily be used for adhesive properties rather than insulative properties. The tape adhesion may join the ribbons of conductive material 2503 together and provide some structural stability. As one strip of tape may be sufficient to provide structural support and adhesion, in specific embodiments tape is only applied to one side of the ribbons of conductive material. The taped side of the ribbon may be in a radial direction of the pole piece.

Composite material ribbons 2540 and 2560 may be for higher voltage applications. For higher voltage application, more insulation of the conductive materials may be beneficial. Accordingly, the insulative properties of the insulative material (e.g., tape) may have increased importance and the tape may be applied to both sides of the ribbons of conductive material. Both taped sides of the ribbon may be in a radial direction of the pole piece. The higher voltage applications may be at voltage levels that could be deemed to be dangerous; direct contact may cause harm due to electrical current passing through a person or animal's body. Such applications may have an insulation requirement (e.g., passing a Hipot test). Although conductive ribbons themselves could be coated in insulative material, the insulative coating may be imperfect. Generally, it is expected for coated wires to have at least one pinhole of missing insulation per meter. Pinholes could result in a compromised insulation between the ribbons of conductive material (e.g., wires) and the ribbons of soft magnetic material (e.g., electrical steel). In the case of compromised insulation, when electricity is applied (e.g., as part of a Hipot test) from copper to motor housing (which is expected to be dead-metal), electrons may arc through the steel ribbon to the rotor by breaking down the very thin (e.g., less than 1 mm) airgap between stator and rotor.

A single ribbon of insulative material (e.g., tape) may be interleaved with (e.g., axially adjacent to) each ribbon of conductive material 2503 to form the composite material ribbon. The single ribbon of insulative material may be wider than the collective width of the set of ribbons of conductive material. For example, the ribbon of insulative material 2502 may have a first width in the axial direction of the axial flux electric machine, the set of ribbons of conductive material 2503 (including each ribbon of conductive material 2503 collectively) may have a second width in the axial direction of the axial flux electric machine. The first width may be larger than the second width.

If the pole piece includes another coil, that coil may also have a ribbon of insulative material. The second set of coiled ribbons of conductive material of the second coil may be coiled in the same direction (e.g., clockwise) as the first set of coiled ribbons of conductive material of the first coil. The second set of coiled ribbons of conductive material (e.g., the second coil) and the first set of coiled ribbons of conductive material (e.g., the first coil) may be adjacent in the axial direction of the axial flux electric machine. The first coil and the second coil may be made of a single composite material ribbon. Accordingly, the ribbons of conductive material of the first coil may be interleaved with a portion of a ribbon of insulative material corresponding to the first coil and the ribbons of conductive material of the second coil are interleaved with another portion of the ribbon of insulative material corresponding to the second coil.

A single ribbon of soft magnetic material 2501 (e.g., steel) may be adjacent to each ribbon of conductive material 2503 to form the composite material ribbon. The single ribbon of soft magnetic material may be wider than the collective width of the set of ribbons of conductive material. For example, ribbon of soft magnetic material 2501 may have a first width in the axial direction of the axial flux electric machine, the set of ribbons of conductive material 2503 (including each ribbon of conductive material 2503 collectively) may have a second width in the axial direction of the axial flux electric machine. The first width may be larger than the second width.

If the pole piece includes another coil, that coil may also have a ribbon of soft magnetic material. The second set of coiled ribbons of conductive material of the second coil may be coiled in the same direction (e.g., clockwise) as the first set of coiled ribbons of conductive material of the first coil. The second set of coiled ribbons of conductive material (e.g., the second coil) and the first set of coiled ribbons of conductive material (e.g., the first coil) may be adjacent in the axial direction of the axial flux electric machine. The first coil and the second coil may be made of a single composite material ribbon. Accordingly, the ribbons of conductive material of the first coil are interleaved with a portion of a ribbon of soft magnetic material corresponding to the first coil and the ribbons of conductive material of the second coil are interleaved with another portion of the ribbon of soft magnetic material corresponding to the second coil.

Splitting a single ribbon of conductive material into multiple ribbons of conductive material as shown in FIG. 25 reduces eddy current losses due to changing magnetic field in the wire. For low voltage applications, it is beneficial to have the conductive ribbon split as it reduces AC losses at higher frequencies. While for the high voltage application, the multiple strands or ribbons of conductive material are utilized by being connected in series rather than parallel, increasing the effective number of turns by multiple times, enabling the motors to be used for a 240V industrial type applications. AC loss occurs as the current travels along the perimeter of the wire and less at the center of the wire as the frequency increases. From this perspective it is desired to increase the total surface area of the wire to reduce the resistance at these higher frequencies, thus splitting the ribbons of conductive material (e.g., wires). The surface area of the wires may be optimized between AC and DC losses, as the conductive material (e.g., copper) fill factor may be reduced with each additional split in the wire due to increased amount of enamel insulation.

In specific embodiments, an insulative tape may act as an insulative sheath, an insulative ribbon, or both. An insulative tape may be able to insulate axially adjacent ribbons of conductive material by bending into the axial gap between the ribbons of conductive material. Portions of the insulative tape may adhere to another ribbon of insulative material or a ribbon of soft magnetic material. A single strip of insulative tape may therefore insulate more than a single side of the set of ribbons of conductive material. Insulative tape may form both insulative material 2504 and insulative material 2506. In this and other embodiments, the geometries of insulative material 2504 and insulative material 2506 may differ from that shown in FIG. 25.

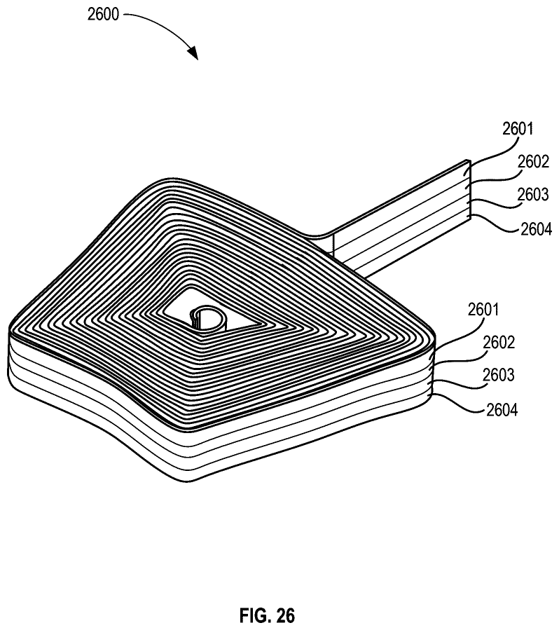

FIG. 26 illustrates an example of a compound interleaved composite material coil 2600 including four coils 2601, 2602, 2603, and 2604 of conductive material in accordance with specific embodiments of the invention. Each coil in FIG. 26 can have layers similar to those of interleaved composite material coil 500. For example, coil 2601 can include a coiled ribbon of conductive material and coil 2602 can include a second, separate, coiled ribbon of conductive material. In specific embodiments, compound interleaved composite material coil 2600 may have one or more ribbons of soft magnetic material and/or ribbons of insulative material that is interleaved with the conductive materials in coils 2601-2604. The one or more ribbons of soft magnetic material and/or ribbons of insulative material may encompass the collective width of coils 2601-2604. In this example, each coil 2601, 2602, 2603, and 2604 may “share” a single ribbon of soft magnetic material and/or a single ribbon of insulative material. In specific embodiments, each composite material coil 2601, 2602, 2603, and 2604 may have its own separate ribbon of soft magnetic material, ribbon of insulative material, or both.

As illustrated, the coiled ribbon of conductive material that is part of coil 2601 is coiled in a first direction (i.e., counter-clockwise) and the respective coiled ribbons of conductive material that are part of coils 2602, 2603, and 2604 are also coiled in the first direction (i.e., counter-clockwise). Furthermore, each coiled ribbon of conductive material is adjacent in the axial direction of the axial flux electric machine. Owing to this configuration, the axial flux of each coiled ribbon of conductive material will be additive. Furthermore, the illustrated approach produces significant benefits in that the combined conductivity of the four coils will be equivalent leading to higher switching speeds while at the same time the width of each individual ribbon has been cut in quarters compared to a single coil having the same conductivity. This is important because wider ribbons have been shown to produce eddy currents which tend to reduce the switching speed and efficiency of the pole piece. The number of separate coiled ribbons in a compound interleaved composite material coil as in FIG. 26 can be further increased to increase the benefit of this effect. In specific embodiments, the ribbons can be adhered to adjacent ribbons using an insulative adherent (e.g., tape) in order for the compound coils to maintain a structural cumulative width sufficient to serve as a freestanding structure. In specific embodiments, each coiled ribbon of conductive material may be each less than 3 centimeters wide as measured in an axial direction of the axial flux electric machine. In specific embodiments of the invention, the number of coiled ribbons of conductive material can be increased to the point where the coiled ribbons of conductive material are instead individual strands of conductive material in a Litz wire.

Using coiled ribbons with smaller widths reduces eddy currents and therefore reduces power loss. Eddy currents are circulating currents induced in a conductive material when it is exposed to a time-varying magnetic flux (per Faraday's law). A major portion of the eddy current on the coils is caused by the magnet fields that are perpendicular to the width of the coil. Theoretical models under simplified conditions suggest that the losses reduce with the thickness of the conductor. Equation 1 below describes eddy current power loss in a conductor.

$${P}_{eddy - width} = 1 / 24 * {w}^{3} * d * l * {( 2 π fB )}^{2} \qquad ( 1 )$$

In equation 1, P_{eddy-width} is the power loss due to eddy currents along the width of the conductor, w is the conductor width, d is the conductor thickness, l is the conductor length, B is the flux density in the width direction, and f is the electrical frequency.

To keep the total resistance of the coil the same (e.g., for the same efficiency), the total width of the ribbons of coils 2601, 2602, 2603, and 2604 collectively should be similar to a coil made up of a single ribbon (e.g., similar to coil 500). With similar total width, the expected total eddy current loss in the coil in the width direction is expected to be lower due to the single ribbon being “split” into multiple ribbons.

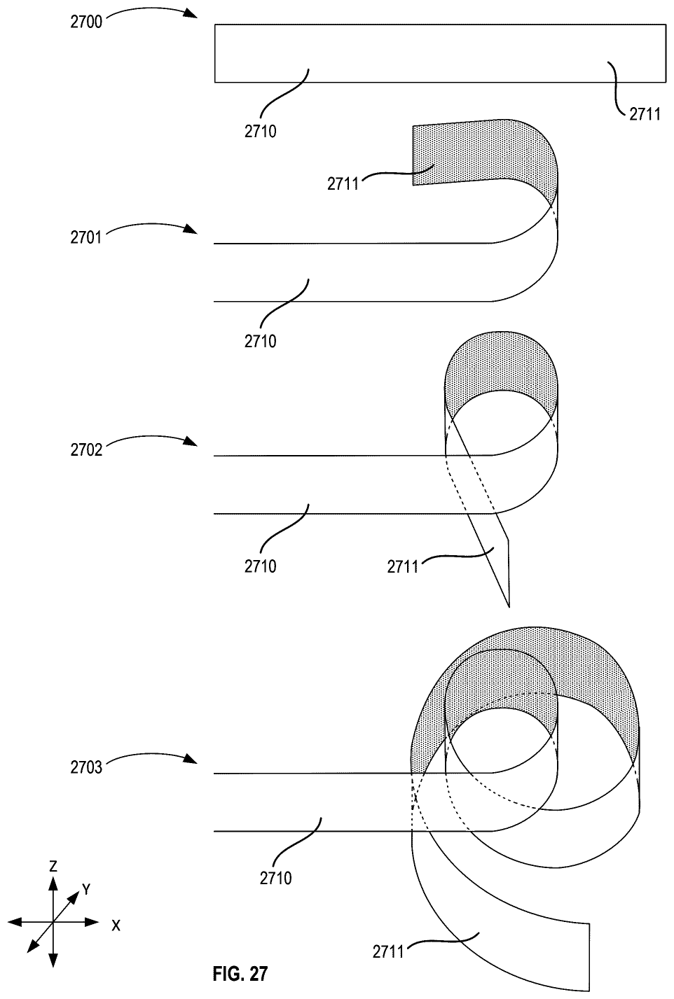

FIG. 27 illustrates the process for forming an internal connection in the form of a gradual fold in a single continuous strip of conductive material in accordance with specific embodiments of the invention. In step 2700, the single continuous strip of conductive material can be provided. As shown, the strip of material can be bent in step 2701 in the same plane as the strip of conductive material. Next, the bent portion can then be further bent in the same direction in step 2702 so that the strip of material forms a spiraled loop. The loop extends in the negative z-direction so that end 2711 is under end 2710. The position of the bends can be selected so that there is a sufficient offset between the plane occupied by the original unbent side of the strip of material (e.g., end 2710) and the bent side of the strip of material (e.g., end 2711) so that the two planes occupied thereby are sufficiently spaced for the coils of the pole piece to be formed.

The strip may be further bent at step 2703. Ends 2710 and 2711 may each extend to form coils of a pole piece. Since the strip of material is oriented in the same direction (e.g., counter-clockwise) on either side of the gradual fold, the coils formed on either side of the fold will be coiled in the same direction and their magnetic flux will be additive. For example, with respect to a current of the axial flux electric machine containing this pole piece, end 2710 may coil in an inward, counterclockwise direction to more a first coil of the pole piece; and end 2711 may coil in an outward, counterclockwise direction to form a second coil of the pole piece. Each end of the pole piece may electrically connect with a different external contact.

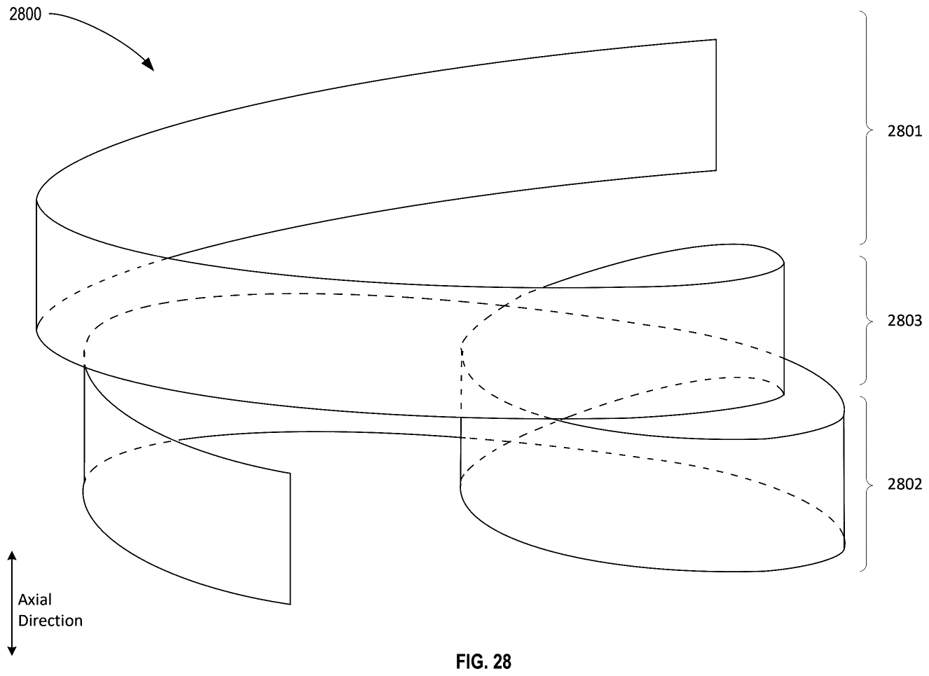

FIG. 28 illustrates a gradual fold winding that acts as an internal connection between two coiled ribbons that are made of a single continuous strip of conductive material in accordance with specific embodiments of the invention. Pole piece 2800 includes first coiled ribbon 2801, second coiled ribbon 2802, and winding 2803 that connects coiled ribbons 2801 and 2802. The coils as shown may be truncated and the spacing as shown may be expanded for clarity. In specific embodiments, the center of the pole piece is occupied by a core of soft magnetic material. The soft magnetic core may allow the gradual fold of the conductive ribbon between coils by allowing the bend to occur on a more outward turn of the coil, where the is more space for a gradual fold.

First coiled ribbon 2801 may be made of conductive material and may be coiled in a first direction (e.g., counterclockwise or clockwise). Second coiled ribbon 2802 may be made of conductive material and may be coiled in that same direction. In specific embodiments, each of first coiled ribbon 2801 and second coiled ribbon 2802 may be composite ribbons that include soft magnetic material and insulative material that separates the soft magnetic material from the conductive material. Second coiled ribbon 2802 and coiled ribbon 2801 may be adjacent in the axial direction of the axial flux electric machine.

In specific embodiments, first coiled ribbon 2801, winding 2803, and second coiled ribbon 2802 may be made of a single continuous ribbon. Winding 2803 may be made of conductive material and may also include soft magnetic material and insulative material. Winding 2803 may electrically connect coiled ribbon 2801 and coiled ribbon 2802 together. Winding 2803 may exit an axial plane of coiled ribbon 2801 and may enter an axial plane of coiled ribbon 2802.

The composite coiled ribbon may be made up of coiled ribbon 2801, winding 2803, and second coiled ribbon 2802. In specific embodiments, winding 2803 may be considered a part of coiled ribbon 2801 or coiled ribbon 2802. The composite coiled ribbon may coil from a first external electrical contact terminal toward a center of the pole piece in a first plane. Coiled ribbon 2801 may refrain from reaching the exact center of the pole piece but may generally coil towards the center. The composite ribbon may bend from the first plane (e.g., of first coiled ribbon 2801) to a second plane (e.g., of second coiled ribbon 2802) via winding 2803. The composite coiled ribbon may coil from the center of the pole piece to a second external electrical contact terminal in the second plane. The composite coiled ribbon may coil from the center of the pole piece as a general indication of direction and does not need to be at the very center of the pole piece. The composite ribbon may form a conductive pathway from the first external electrical contact terminal to the second external electrical contact terminal. Each coiled ribbons 2801 and 2802 may present an external electrical contact for the pole piece on an outermost turn of the respective coil. In this way, each external electrical contact may be electrically connected.

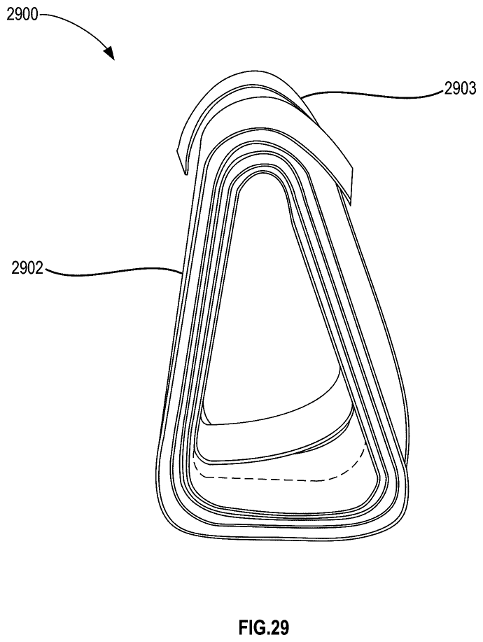

FIG. 29 illustrates pole piece 2900 that has been formed using a gradual fold in accordance with specific embodiments of the invention. Pole piece 2900 may have been formed using the approaches illustrated in FIGS. 27 and 28; two coils have been formed by a single continuous strip of conductive material and a single continuous strip of soft magnetic material with both strips of material being bent according to the process in FIG. 27. As illustrated, the pole piece includes two external electrical contacts and the two coils are oriented such that their magnetic flux is additive (i.e., both coils are coiled counter-clockwise with coil 2902 coiling inward and coil 2903 coiling outward). The dashed line indicates the boundary between coils 2902 and 2903. Turns of the continuous strip of conductive material, including the inter-plane connection, may be electrically insulated from each other.

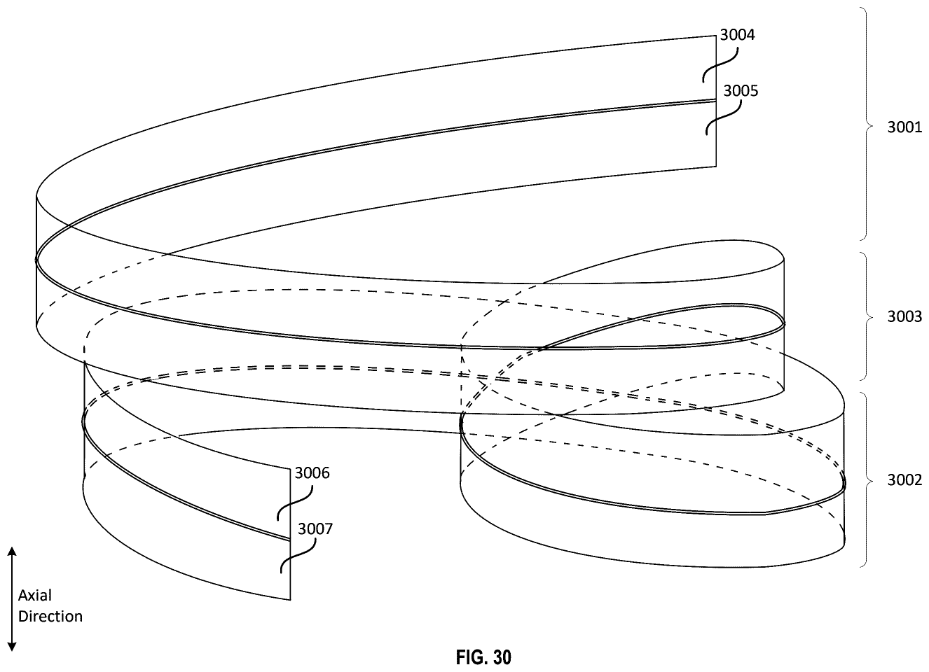

FIG. 30 illustrates a gradual fold pattern to allow a first set of ribbons of conductive material in a first coil to connect to a second set of ribbons of conductive material in a second coil in accordance with specific embodiments of the invention. The gradual fold pattern utilizes the folds described with reference to FIGS. 27-29 with the folds being applied to a set of ribbons rather than a single ribbon. First coil 3001 can include a set of internal windings 3003 in order to connect to second coil 3002, where the two coils are oriented as the coils are with reference to FIGS. 9 and 10. Two single ribbons of conductive material 3004 and 3005 may be gradually folded such that they can form winding 3003 connecting first coil 3001 and second coil 3002. The set of ribbons of conductive material 3004 and 3005 of first coil 3001 may enter a gradual fold (e.g., winding 3003), which may transfer into a different plane, and then form second coil 3002. As the strips of material (e.g., ribbons of conductive material 3004, 3005, 3006, and 3007) are oriented in the same direction on either side of the fold, both coils 3001 and 3002 will coil in the same direction and can have additive magnetic flux. At the same time, first coil 3001 can coil inward and second coil 3002 can coil outward such that a pole piece formed by the two compound coils can have two external electrical connections.

Although coils 3001 and 3002 are each shown with two ribbons of conductive material, coils may be composed of any quantity of ribbons of conductive material. Each coiled ribbon of conductive material may coil from a first external electrical contact terminal towards a center of the pole piece in a first plane. Each coiled ribbon may then bend from the first plane to a second plane. The second plane may be the axial plane of the second coil. Each coiled ribbon may then coil from the center of the pole piece to a second external electrical contact terminal in the second plane. In this example, each coiled ribbon may form a conductive pathway from the first external electrical contact terminal to the second external electrical contact terminal. Each coiled ribbon of conductive material in the set of coiled ribbons of conductive material may present an external electrical contact for the pole piece on an outermost turn of the coiled ribbon and each external electrical contact may be electrically connected to the other external electrical contacts in the set of ribbons of the coil. In specific embodiments, each coiled ribbon of conductive material in the set of coiled ribbons of conductive material may be at least partially sheathed by insulative material.

Ribbon of conductive material 3004 and ribbon of conductive material 3006 may form a single ribbon of conductive material across coil 3001, winding 3003, and coil 3002. The single ribbon of conductive material may have a consistent width. The width may be measured generally in the axial direction of the pole piece, with a slight tilt during winding 3003 during which the ribbon of conductive material may be tilted to change planes. The single ribbon of conductive material across coil 3001, winding 3003, and coil 3002 may include at least two straight sides that each extend the length comprising the turns of coil 3001, winding 3003, and coil 3002. Likewise, ribbon of conductive material 3005 and ribbon of conductive material 3007 may form a single ribbon of conductive material across coil 3001, winding 3003, and coil 3002, with a similarly consistent width and two straight sides.

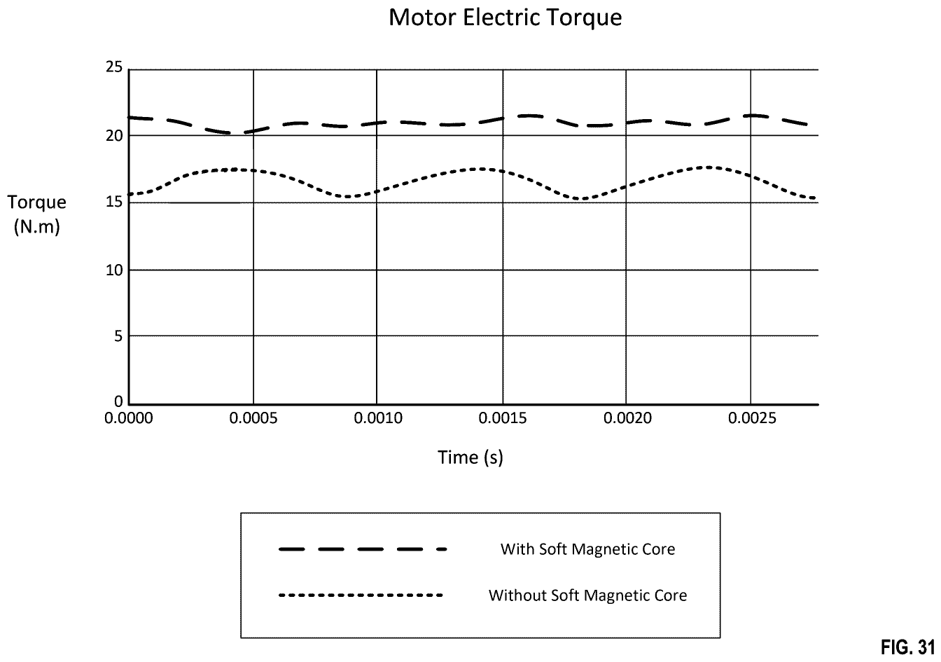

FIG. 31 illustrates the results of a simulation of torque for an electric motor with a soft magnetic core as described herein and an electric motor without a soft magnetic core. The simulation was conducted with both motors operating at 3600 rpm and with motor currents at 240 A rms. In FIG. 31, the x-axis represents time in seconds during the simulation, and the y-axis represents the torque of the motor in Newton meters. As can be seen in the figure, the resulting average torque for the motor with the soft magnetic core was 21 Newton meters and the resulting average torque for the motor without the soft magnetic core was 16.57 Newton meters. The coil with the soft magnetic core shows 27% improvement in torque production in some motor configurations. The addition of the soft magnetic core piece reduces the magnetic reluctance in the path of the magnet flux leading to a higher flux density across the airgap. The addition of soft magnetic core also reduces the leakage flux, helping the magnet flux to link more effectively with the stator flux. Therefore, the coil with the soft magnetic core creates higher flux density across the airgap surface area, which results in higher torque. In addition, the soft magnetic core reduces the cogging torque and the torque ripple of the motor.

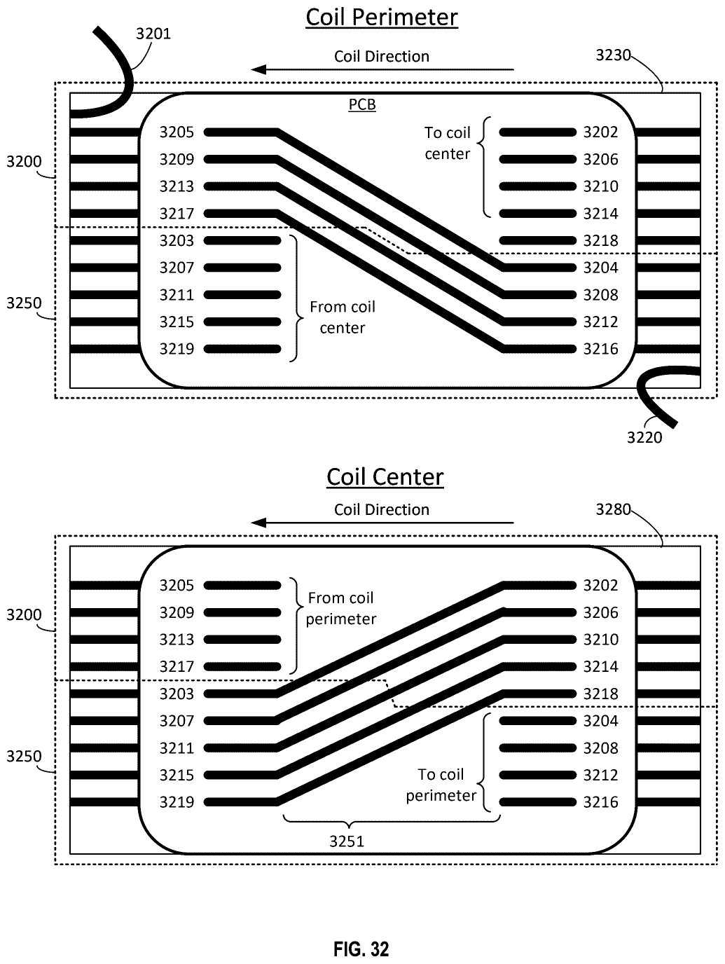

FIG. 32 illustrates two coils with split ribbons that are connected in series in accordance with specific embodiments of the invention. View 3230 shows a portion of the perimeter of the two coils, with the outermost turn of each ribbon illustrated. View 3230 shows a printed circuit board (PCB) that connects ribbons of conductive material (e.g., wires) of coil 3250 to ribbons of conductive material of coil 3200. Each ribbon 3201-3220 extends on either side of the PCB and loops or coils around to form a portion of the corresponding coil. View 3280 shows a portion of the inside of the two coils, with the innermost turn of each ribbon illustrated. View 3280 shows a PCB-like structure, although this is for illustrative purposes, as the transitions between ribbons as indicated may simply be gradually folds without the use of a PCB. View 3280 shows how ribbons of conductive material (e.g., wires) of coil 3200 connect to ribbons of conductive material of coil 3250. Each ribbon 3201-3220 extends on either side of the PCB-like structure and loops or coils around to form a portion of the corresponding coil. The additional connections between ribbons is not shown in FIG. 32 for the sake of clarity of the series connections between coils.

Coil 3200 and coil 3250 are axially adjacent in the axial direction of an axial flux electric machine. Coil 3200 and coil 3250 each include a set of coiled ribbons of conductive material and form part of a pole piece. Coil 3200 includes coiled ribbons 3201, 3202, 3205, 3206, 3213, 3214, 3217, and 3218, each ribbon being made of conductive material. Coil 3250 includes coiled ribbons 3203, 3204, 3207, 3208, 3211, 3212, 3215, 3216, 3219, and 3220, each ribbon being made of conductive material. Each of these coiled ribbons are connected to each other in series. Conductive ribbons may be separated (except where they connect to each other as described below) via an insulative material. The insulative material may be a coating, a ribbon, or a tape. Each coiled ribbon 3201-3220 is coiled in a first direction (e.g., clockwise from a top view with reference to a current of the axial flux electric machine). Ribbons in coil 3200 are coiled inward and ribbons in coil 3250 are coiled outward. In specific embodiments, coils 3200 and 3250 may have soft magnetic cores. As described in more detail below, ribbons 3201-3220 are connected in series according to numerical ascending order as they are labeled: 3201, 3202, 3203, 3204, 3205, 3206, 3207, 3208, 3209, 3210, 3211, 3212, 3213, 3214, 3215, 3216, 3217, 3218, 3219, and 3220.

The connection between separate coils of conductive materials that are spaced apart axially in the axial electrical machine can be provided in various ways. In specific embodiments, as in the example of FIG. 32, a single ribbon of conductive material can form multiple coils as a single piece and can alternately form portions of the different coils. Accordingly, an interleaved composite material coil having such a single ribbon of conductive material can inwardly coil from a first external electrical contact terminal towards the center of the pole piece in a first plane, bend or curve from a first plane in which the first coil is located into a second plane in which the second coil is located, and then outwardly coil from the center of the pole piece to a second external electrical contact terminal in the second plane. The single continuous strip of conductive material can be bent and coiled to form two coils, each split into five ribbons according to the connections shown in FIG. 32.

A set of windings 3251, made of conductive material, electrically connect coiled ribbons 3202, 3206, 3210, 3214, and 3218 in coil 3200 and coiled ribbon 3203, 3207, 3211, 3215, and 3219 in coil 3250 in a one-to-one correspondence. Set of windings 3251 and coiled ribbons 3201-3220 may be connected to each other in series. To electrically connect coiled ribbons 3202, 3206, 3210, 3214, and 3218 in coil 3200 and coiled ribbon 3203, 3207, 3211, 3215, and 3219 in coil 3250 in a one-to-one correspondence, each winding in set of windings 3251 may exit an axial plane of one of the coiled ribbons in coil 3200 and may enter an axial plane of the corresponding coiled ribbon in coil 3250. All of the ribbons in coil 3200 coil into the center and then fold at the center so that they extend to plane of coil 3250. The ribbons in coil 3250 continue winding in the same way from the center to the outside. Once the ribbons get back to the outside, they connect up to the next wire in coil 3200. An insulative tape may be in contact with each winding in set of windings 3251.

The conductive path of the coil pair starts at ribbon 3201, which is connected to a first external electrical contact terminal (not shown). The first external electrical contact terminal may be the source. Ribbon 3201 winds around the perimeter of the coil once, to connect to ribbon 3202. Ribbon 3202 coils (e.g., with multiple turns) inward towards the center of coil 3200, where it then connects (e.g., via a gradual fold) to ribbon 3203 in coil 3250. Ribbon 3203 coils once around the inside of coil 3250 to connect with ribbon 3204. Ribbon 3204 coils (e.g., with multiple turns) toward the perimeter (e.g., outward from the center) of coil 3250. Ribbon 3204 of coil 3250 connects to ribbon 3205 of coil 3200 at the perimeter of the coils. Ribbon 3205 winds around the perimeter of coil 3200 once, to connect to ribbon 3206, which then coils inward and connects (e.g., via a gradual fold) to ribbon 3207 of coil 3250. Ribbon 3207 coils around the inside of coil 3250 once to connect with ribbon 3208. Ribbon 3208 coils outward to connect with ribbon 3209 of coil 3200. This process continues such that the ribbons are connected in series according to numerical ascending order as they are labeled: 3201, 3202, 3203, 3204, 3205, 3206, 3207, 3208, 3209, 3210, 3211, 3212, 3213, 3214, 3215, 3216, 3217, 3218, 3219, and 3220. Ribbon 3220 is connected to a second external electrical contact terminal (not shown). The second external electrical contact terminal may be ground or neutral.

In specific embodiments, coils 3200 and 3250 may be composed of a single continuous conductive ribbon (e.g., as well as other materials). In specific embodiments, coils 3200 and 3250 may not be made of a single continuous ribbon. Instead, coils 3200 and 3250 may be made of multiple portions of conductive ribbon that interface with other conductive components such as printed circuit boards.

Connecting the ribbons of the coils in series in the manner depicted in FIG. 32 is beneficial for high voltage applications. The multiple ribbons (e.g., strands) being connected in series (e.g., rather than parallel) increases the effective number of turns by multiple times, enabling the motors to be used for 240V industrial type applications. AC loss occurs as the current travels along the perimeter of the wire (e.g., conductive portion of a ribbon) and less at the center of the wire as the frequency increases. From this perspective it is desirable to increase the total surface area of the wire to reduce the resistance at these higher frequencies, thus splitting a single wire into multiple wires (e.g., a ribbon of conductive material into five ribbons of conductive material). Surface area of a wire is a parameter that can be optimized between AC and DC losses, as the copper fill factor is reduced with each additional split in the wire due to increased amount of enamel insulation.

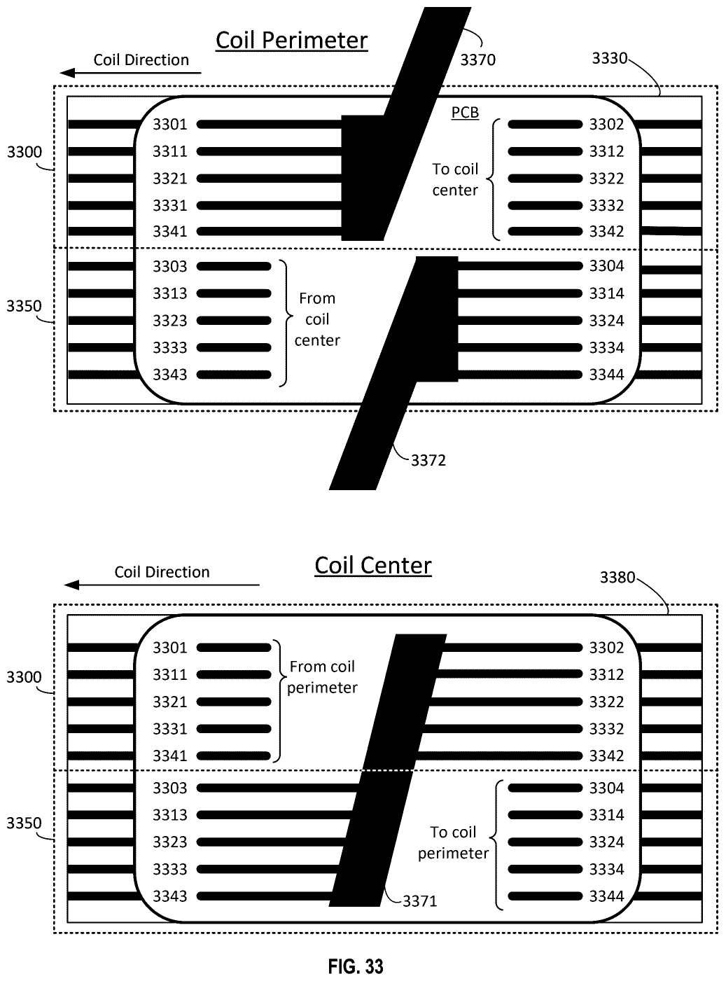

FIG. 33 illustrates two coils with split ribbons with each ribbon of a coil connected in parallel in accordance with specific embodiments of the invention. View 3330 shows a portion of the perimeter of the two coils, with the outermost turn of each ribbon illustrated. View 3330 shows a PCB that connects ribbons of conductive material (e.g., wires) of coil 3350 to an external contact and that connects ribbons of conductive material of coil 3300 to a second external contact. The PCB may be for illustrative purposes, as the ribbons may be connected in other ways. As shown, each ribbon 3301-3304, 3311-3314, 3321-3324, 3301-3304, and 3341-3344 extends on either side of the PCB and loops or coils around to form a portion of the corresponding coil. View 3380 shows a portion of the inside of the two coils, with the innermost turn of each ribbon illustrated. View 3380 shows a PCB-like structure, although this is for illustrative purposes, as the transitions between ribbons as indicated may simply be gradually folds without the use of a PCB. View 3380 shows how ribbons of conductive material (e.g., wires) of coil 3300 connect to ribbons of conductive material of coil 3350. Each ribbon extends on either side of the PCB-like structure and loops or coils around to form a portion of the corresponding coil. The additional connections between ribbons is not shown in FIG. 32 for the sake of clarity of the parallel configuration of each coil and the connection of the two coils.

Coil 3300 and coil 3350 are axially adjacent in the axial direction of an axial flux electric machine. Coil 3300 and coil 3350 each include a set of coiled ribbons of conductive material and form part of a pole piece. Coil 3300 includes coiled ribbons 3301, 3302, 3311, 3312, 3321, 3322, 3331, 3332, 3341, 3342, each ribbon being made of conductive material. Coil 3350 includes coiled ribbons 3303, 3304, 3313, 3314, 3323, 3324, 3333, 3334, 3343, and 3344, each ribbon being made of conductive material. Each ribbons in coil 3300 is connected to each other in parallel. Each ribbon in coil 3350 is connected to each other in parallel. Coil 3300 and 3350 are connected together in series. Conductive ribbons may be separated (except where they connect to each other as described below) via an insulative material. The insulative material may be a coating, a ribbon, or a tape. Each coiled ribbon may be coiled in the same direction (e.g., clockwise from a top view with reference to a current of the axial flux electric machine). Ribbons in coil 3300 are coiled inward and ribbons in coil 3350 are coiled outward. In specific embodiments, coils 3300 and 3350 may have soft magnetic cores.

The connection between separate coils of conductive materials that are spaced apart axially in the axial electrical machine can be provided in various ways. In specific embodiments, as in the example of FIG. 33, a single ribbon of conductive material may split and rejoin to form multiple coils. An interleaved composite material ribbon may split to form several ribbons that each inwardly coil from a first external electrical contact terminal towards the center of the pole piece in a first plane, forming the first coil. The split ribbons may join back together as a single ribbon and may bend or curve from a first plane in which the first coil is located into a second plane in which the second coil is located. The ribbon may then split again to form several ribbons that each outwardly coil from the center of the pole piece, forming the second coil. The split ribbons may join back together and connect with a second external electrical contact terminal in the second plane. Each coiled ribbon of conductive material in the set of coiled ribbons of conductive material may present an external electrical contact for the pole piece on an outermost turn of the coiled ribbon. Each external electrical contact may connect with an external electrical contact terminal. Each external electrical contact may be electrically connected to each other external electrical contact corresponding to the set of coiled ribbons (e.g., via the external electrical contact terminal).

Winding 3371, made of the joined splits of ribbons of conductive material may

electrically connect coiled ribbons 3302, 3303, 3312, 3313, 3322, 3323, 3332, 3333, 3342, and 3343 together. To electrically connect ribbons 3302, 3312, 3322, 3332, and 3342 in coil 3300 to ribbons 3303, 3312, 3313, 3333, and 3343 in coil 3350, winding 3371 may exit an axial plane of coil 3300 and may enter an axial plane coil 3350. All of the ribbons in coil 3300 may coil into the center and then gradually fold at the center so that they extend to plane of coil 3350. The ribbons in coil 3350 may continue winding in the same way from the center to the outside.

The conductive path of the coil pair starts at ribbon 3370, which is connected to a first external electrical contact terminal (not shown). The first external electrical contact terminal may be the source. Ribbon 3370 is a split into ribbons 3301, 3311, 3321, 3331, and 3341. Each of ribbons 3301, 3311, 3321, 3331, and 3341 winds around the perimeter of coil 3300 once, to connect to ribbons 3302, 3312, 3322, 3332, and 3342 respectively. Ribbons 3302, 3312, 3322, 3332, and 3342 each coil (e.g., with multiple turns) inward towards the center of coil 3300, where they then connect back together at winding 3371 (winding 3371 may be made up of a ribbon of conductive material). In this way, the ribbons of coil 3300 are connected in parallel. Winding 3371 may perform a gradual fold from the axial plane of coil 3300 to the axial plane of coil 3350. An insulative tape may be in contact with winding 3371.

Winding 3371 may be split into ribbons 3303, 3313, 3323, 3333, and 3343. Each of ribbons 3303, 3313, 3323, 3333, and 3343 may wind around the inside of coil 3350 once, to connect to ribbons 3304, 3314, 3324, 3334, and 3344 respectively. Ribbons 3304, 3314, 3324, 3334, and 3344 each coil (e.g., with multiple turns) outward towards the perimeter of coil 3350, where they then connect back together at ribbon 3372. In this way, the ribbons of coil 3350 are connected in parallel. Ribbon 3372 may connect to a second external electrical contact terminal (not shown). The second external electrical contact terminal may be ground or neutral.

Connecting the ribbons of the coils in parallel in the manner depicted in FIG. 33 is beneficial for low voltage applications. With the low voltage application it is beneficial to have the wire split as it reduces AC losses at higher frequencies.

While the specification has been described in detail with respect to specific embodiments of the invention, it will be appreciated that those skilled in the art, upon attaining an understanding of the foregoing, may readily conceive of alterations to, variations of, and equivalents to these embodiments. Although examples in the disclosure were generally directed to axial flux electric machines in the form of axial flux motors, embodiments disclosed herein are equally applicable to axial flux generators. As another example, the compound coils disclosed herein can be used in place of any of the individual coils described herein. Additionally, at any point that an interleaved composite material coil is mentioned, a standalone sheathed ribbon of conductive material could be used in its place. These and other modifications and variations to the present invention may be practiced by those skilled in the art, without departing from the scope of the present invention, which is more particularly set forth in the appended claims.

What is claimed is:

1. An axial flux electric machine comprising:
a stator having a plurality of pole pieces;
a set of coiled ribbons of conductive material forming at least part of a pole piece in the plurality of pole pieces; and
an insulative material that isolates each coiled ribbon of conductive material in the set of coiled ribbons of conductive material;
wherein each coiled ribbon of conductive material is adjacent to other coiled ribbons of conductive material in the set of coiled ribbons of conductive material in an axial direction of the axial flux electric machine; and
wherein an axial direction of the set of coiled ribbons of conductive material is substantially parallel to the axial direction of the axial flux electric machine.

2. The axial flux electric machine of claim 1, wherein each coiled ribbon of conductive material is at least partially sheathed by the insulative material.

3. The axial flux electric machine of claim 2, further comprising a second insulative material in the form of a tape in contact with a side of the coiled ribbons in the set of coiled ribbons, the side being in a radial direction of the pole piece.

4. The axial flux electric machine of claim 3, further comprising a third insulative material in the form of a second tape in contact with a second side of the coiled ribbons in the set of coiled ribbons, the second side being in radial direction of the pole piece.

5. The axial flux electric machine of claim 1, further comprising:
a coiled ribbon of soft magnetic material forming at least part of the pole piece;
wherein the coiled ribbon of soft magnetic material and the set of coiled ribbons of conductive material are commonly coiled in an interleaved composite material coil; and
the insulative material isolates the set of coiled ribbons of conductive material from the coiled ribbon of soft magnetic material.

6. The axial flux electric machine of claim 5, wherein:
the coiled ribbon of soft magnetic material has a first width in the axial direction of the axial flux electric machine;
the set of coiled ribbons of conductive material, including each coiled ribbon of conductive material collectively, has a second width in the axial direction of the axial flux electric machine; and
the first width is larger than the second width.

7. The axial flux electric machine of claim 1, wherein each coiled ribbon of conductive material in the set of coiled ribbons of conductive material is connected to each other in series.

8. The axial flux electric machine of claim 7, further comprising:
a second set of coiled ribbons of conductive material forming at least part of the pole piece;
wherein: (i) the set of coiled ribbons of conductive material is coiled in a first direction; (ii) the second set of coiled ribbons of conductive material is coiled in the first direction; (iii) the second set of coiled ribbons of conductive material and the set of coiled ribbons of conductive material are adjacent in the axial direction of the axial flux electric machine; (iv) a set of windings of conductive material electrically connect each coiled ribbon in the second set of coiled ribbons of conductive material and each coiled ribbon in the set of coiled ribbons of conductive material in a one-to-one correspondence; and (v) the set of windings, the set of coiled ribbons of conductive material, the second set of coiled ribbons of conductive material are connected to each other in series.

9. The axial flux electric machine of claim 8, wherein to electrically connect each coiled ribbon in the second set of coiled ribbons of conductive material and each coiled ribbon in the set of coiled ribbons of conductive material in a one-to-one correspondence:
each winding in the set of windings exits an axial plane of the corresponding coiled ribbon in the set of coiled ribbons of conductive material and enters an axial plane of the corresponding coiled ribbon in the second set of coiled ribbons of conductive material.

10. The axial flux electric machine of claim 1, wherein each coiled ribbon of conductive material in the set of coiled ribbons of conductive material is connected to each other in parallel.

11. The axial flux electric machine of claim 10, further comprising:
a second set of coiled ribbons of conductive material forming at least part of the pole piece;
wherein: (i) each coiled ribbon of conductive material in the second set of coiled ribbons of conductive material is connected to each other in parallel; (ii) the set of coiled ribbons of conductive material is coiled in a first direction; (iii) the second set of coiled ribbons of conductive material is coiled in the first direction; (iv) the second set of coiled ribbons of conductive material and the set of coiled ribbons of conductive material are adjacent in the axial direction of the axial flux electric machine; (v) a winding of conductive material electrically connects each coiled ribbon in the second set of coiled ribbons of conductive material and each coiled ribbon in the set of coiled ribbons of conductive material.

12. The axial flux electric machine of claim 11, further comprising an insulative tape that is in contact with the winding.

13. The axial flux electric machine of claim 1, further comprising:
a second set of coiled ribbons of conductive material forming at least part of the pole piece;
wherein: (i) the set of coiled ribbons of conductive material is coiled in a first direction; (ii) the second set of coiled ribbons of conductive material is coiled in the first direction; (iii) the second set of coiled ribbons of conductive material and the set of coiled ribbons of conductive material are adjacent in the axial direction of the axial flux electric machine; (iv) a set of windings of conductive material electrically connect each coiled ribbon in the second set of coiled ribbons of conductive material and each coiled ribbon in the set of coiled ribbons of conductive material in a one-to-one correspondence; and (v) the set of windings exits an axial plane of the corresponding coiled ribbon in the set of coiled ribbons of conductive material and enters an axial plane of the corresponding coiled ribbon in the second set of coiled ribbons of conductive material.

14. The axial flux electric machine of claim 12, wherein the first direction is clockwise with reference to a current in the axial flux electric machine.

15. The axial flux electric machine of claim 1, wherein:
each coiled ribbon of conductive material in the set of coiled ribbons of conductive material presents an external electrical contact for the pole piece on an outermost turn of the coiled ribbon; and
each external electrical contact is electrically connected to each other external electrical contact corresponding to the set of coiled ribbons.

16. The axial flux electric machine of claim 1, wherein each coiled ribbon of conductive material:
coils from a first external electrical contact terminal towards a center of the pole piece in a first plane;
bends from the first plane to a second plane;
coils from the center of the pole piece to a second external electrical contact terminal in the second plane; and
forms a conductive pathway from the first external electrical contact terminal to the second external electrical contact terminal.

17. An axial flux electric machine, comprising:
a stator having a plurality of pole pieces;
a first coiled ribbon of conductive material forming at least part of a pole piece in the plurality of pole pieces; and
a second coiled ribbon of conductive material forming at least part of the pole piece;
wherein: (i) the first coiled ribbon of conductive material is coiled in a first direction; (ii) the second coiled ribbon of conductive material is coiled in the first direction; (iii) the second coiled ribbon of conductive material and the first coiled ribbon of conductive material are adjacent in an axial direction of the axial flux electric machine; (iv) a winding of the first coiled ribbon of conductive material exits an axial plane of the first coiled ribbon of conductive material and enters an axial plane of the second coiled ribbon of conductive material; and (v) the winding electrically connects the second coiled ribbon of conductive material and the first coiled ribbon of conductive material.

18. The axial flux electric machine of claim 17, wherein the first coiled ribbon of conductive material, the second coiled ribbon of conductive material, and the winding are made of a single ribbon of conductive material with a consistent width.

19. The axial flux electric machine of claim 17, wherein:
the first coiled ribbon of conductive material, the second coiled ribbon of conductive material, and the winding are made of a single ribbon of conductive material; and
the single ribbon of conductive material includes at least two straight sides that each extend a length comprising the first coiled ribbon of conductive material, the second coiled ribbon of conductive material, and the winding.

20. The axial flux electric machine of claim 17, further comprising:
a soft magnetic material core located within an innermost turn of the pole piece.

21. The axial flux electric machine of claim 20, wherein the soft magnetic material core extends from one side of the innermost turn to an opposite side of the innermost turn of the pole piece.

22. An axial flux electric machine comprising:
a stator having a plurality of pole pieces;
a coiled ribbon of conductive material forming at least part of a pole piece in the plurality of pole pieces and having a first width in an axial direction of the axial flux electric machine;
a coiled ribbon of soft magnetic material forming at least part of the pole piece and having a second width in the axial direction of the axial flux electric machine; and
an insulative material;
wherein: (i) the coiled ribbon of soft magnetic material and the coiled ribbon of conductive material are commonly coiled in an interleaved composite material coil; (ii) an axial direction of the interleaved composite material coil is substantially parallel to the axial direction of the axial flux electric machine; (iii) the insulative material isolates the coiled ribbon of conductive material from the coiled ribbon of soft magnetic material; and (iv) the second width is larger than the first width.

23. The axial flux electric machine of claim 22, wherein the coiled ribbon of conductive material is at least partially sheathed by the insulative material.

24. The axial flux electric machine of claim 22, wherein the insulative material is in the form of a tape on a side of the coiled ribbon of conductive material, the side being in a radial direction of the pole piece.
